(19) United States
(12) Patent Application Publication
(10) Pub. No.: US 2026/0178081 A1
(43) Pub. Date: Jun. 25, 2026

(54) Foldable Display Panel and Foldable Display Apparatus

(71) Applicants: CHENGDU BOE OPTOELECTRONICS TECHNOLOGY CO., LTD., Chengdu, Sichuan (CN); BOE TECHNOLOGY GROUP CO., LTD., Chaoyang District, Beijing (CN)

(72) Inventors: Feifan Li, Beijing (CN); Shuang Lei, Beijing (CN); Dianjie Hou, Beijing (CN); Yanli Wang, Beijing (CN); Huinan Shi, Beijing (CN); Liang Gao, Beijing (CN); Xu Lu, Beijing (CN); An Fu, Beijing (CN)

(21) Appl. No.: 19/126,702

(22) PCT Filed: Jul. 24, 2024
(86) PCT No.: PCT/CN2024/107349

§ 371 Date: May 2, 2025

(30) Foreign Application Priority Data
Aug. 30, 2023 (CN) 202311110585.8

(51) Int. Cl. G06F 1/16

(52) U.S. Cl. CPC G06F 1/1641

(57) ABSTRACT

A foldable display panel has a display area and a light-transmitting area. The foldable display panel includes a display substrate, a transparent cover plate located on a light-exit side of the display substrate, a first buffer layer located between the transparent cover plate and the display substrate, a first protective layer located on a side of the transparent cover plate away from the first buffer layer, and a first light-shielding layer located between the transparent cover plate and the display substrate. An elastic modulus of the first protective layer is greater than an elastic modulus of the first buffer layer. The first light-shielding layer surrounds at least part of the light-transmitting area. The first light-shielding layer includes a first opening, and a orthogonal projection of the light-transmitting area on the transparent cover plate at least partially overlaps with an orthogonal projection of the first opening on the transparent cover plate.

### CROSS-REFERENCE TO RELATED APPLICATIONS

This application is the United States national phase of International Patent Application No. PCT/CN2024/107349, filed Jul. 24, 2024, and claims priority to Chinese Patent Application No. 202311110585.8, filed Aug. 30, 2023, the disclosures of which are hereby incorporated by reference in their entireties.

### BACKGROUND OF THE INVENTION

### Field of the Invention

The present disclosure relates to the field of display technologies, in particular to, a foldable display panel and a foldable display apparatus.

### Description of Related Art

OLED (Organic light-emitting diode) display apparatuses have become one of highly competitive and development promising display apparatuses currently due to self-luminescence, fast response speed, high brightness, full viewing angle, flexible display, and other advantages.

### SUMMARY OF THE INVENTION

In an aspect, a foldable display panel is provided. The foldable display panel has a display area and a light-transmitting area. The foldable display panel includes a display substrate, a transparent cover plate, a first buffer layer, a first protective layer and a first light-shielding layer. The display substrate includes an opening, and the opening is located in the light-transmitting area. The transparent cover plate is located on a light-exit side of the display substrate. The first buffer layer is located between the transparent cover plate and the display substrate. The first protective layer is located on a side of the transparent cover plate away from the first buffer layer. A material of the first protective layer is different from a material of the first buffer layer, and an elastic modulus of the first protective layer is greater than an elastic modulus of the first buffer layer. The first light-shielding layer is located between the transparent cover plate and the display substrate. The first light-shielding layer surrounds at least part of the light-transmitting area. The first light-shielding layer includes a first opening, and an orthogonal projection of the light-transmitting area on the transparent cover plate at least partially overlaps with an orthogonal projection of the first opening on the transparent cover plate.

In some embodiments, the first light-shielding layer is located between the first buffer layer and the transparent cover plate, or the first light-shielding layer is located between the first buffer layer and the display substrate.

In some embodiments, the foldable display panel further includes a second buffer layer. The second buffer layer is located between the transparent cover plate and the first buffer layer. A material of the second buffer layer is different from the material of the first buffer layer, and an elastic modulus of the second buffer layer is less than or equal to the elastic modulus of the first buffer layer. The first light-shielding layer is located between the second buffer layer and the transparent cover plate, or the first light-shielding layer is located between the second buffer layer and the first buffer layer.

In some embodiments, the elastic modulus of the second buffer layer is in a range of 5 MPa to 100 MPa, inclusive.

In some embodiments, a thickness of the second buffer layer is in a range of 50 μm to 200 μm, inclusive.

In some embodiments, a thickness of the second buffer layer is in a range of 80 μm to 120 μm, inclusive.

In some embodiments, the foldable display panel further includes an encapsulation layer and a color filter structure layer. The encapsulation layer is located on a side of the display substrate proximate to the transparent cover plate. The color filter structure layer is located on a side of the encapsulation layer proximate to the transparent cover plate. The color filter structure layer includes a black matrix layer. The first light-shielding layer and the black matrix layer are disposed in a same layer.

In some embodiments, the foldable display panel further has a bending area located on a side of the display area. The first buffer layer includes a first side edge and a second side edge that are disposed opposite to each other, and the first side edge is located on a side of the second side edge proximate to the bending area. The first side edge includes a first line segment, a first arc transition segment, a second line segment, a second arc transition segment and a third line segment that are connected in sequence. The second line segment protrudes toward the second side edge relative to the first line segment and the third line segment to define a groove structure, bottom corners of the groove structure are round corners, and the groove structure is located in the bending area.

In some embodiments, the elastic modulus of the first protective layer is in a range of 5.5 GPa to 7.5 GPa, inclusive.

In some embodiments, the first protective layer includes a protective substrate, a material of the protective substrate includes transparent polyimide, and a thickness of the transparent polyimide is in a range of 50 μm to 80 μm, inclusive.

In some embodiments, the thickness of the transparent polyimide is in a range of 70 μm to 80 μm, inclusive.

In some embodiments, the first protective layer further includes a hard coating, and the hard coating is located on a side of the protective substrate away from the display substrate.

In some embodiments, a thickness of the hard coating is in a range of 5 μm to 20 μm, inclusive.

In some embodiments, the elastic modulus of the first buffer layer is in a range of 3.5 GPa to 4.5 GPa, inclusive.

In some embodiments, a thickness of the first buffer layer is in a range of 20 μm to 100 μm, inclusive.

In some embodiments, the thickness of the first buffer layer is in a range of 20 μm to 50 μm, inclusive.

In some embodiments, the orthogonal projection of the light-transmitting area on the transparent cover plate covers the orthogonal projection of the first opening on the transparent cover plate.

In some embodiments, the foldable display panel further includes a second light-shielding layer. The second light-shielding layer is located on a side of the first protective layer proximate to the display substrate, and the second light-shielding layer surrounds at least part of the display area.

In some embodiments, the second light-shielding layer and the first light-shielding layer are disposed in a same layer.

In some embodiments, the first protective layer includes a groove, and the groove surrounds at least part of the light-transmitting area. The foldable display panel further includes a third light-shielding layer, and the third light-shielding layer is located in the groove.

In yet another aspect, a foldable display apparatus is provided. The foldable display apparatus includes the foldable display panel as described in any of the above embodiments.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, but are not limitations on an actual size of a product, an actual process of a method and an actual timing of a signal to which the embodiments of the present disclosure.

FIG. 1 is a structural diagram of a foldable display apparatus, in accordance with some embodiments;

FIG. 2 is a cross-sectional view taken along a section line B-B′ in FIG. 1;

FIG. 3 is a plan view of a foldable display apparatus, in accordance with some embodiments;

FIG. 4 is a plan view of another foldable display apparatus, in accordance with some embodiments;

FIG. 5 is another cross-sectional view taken along a section line B-B′ in FIG. 1;

FIG. 6 is a structural diagram of another foldable display apparatus, in accordance with some embodiments;

FIG. 7 is a structural diagram of a foldable display panel, in accordance with some embodiments;

FIG. 8 is a structural diagram of another foldable display panel, in accordance with some embodiments;

FIG. 9 is a structural diagram of another foldable display panel, in accordance with some embodiments;

FIG. 10 is a structural diagram of a foldable display panel, in accordance with some implementations;

FIG. 11 is a structural diagram of another foldable display panel, in accordance with some embodiments;

FIG. 12 is a structural diagram of another foldable display panel, in accordance with some embodiments;

FIG. 13 is a structural diagram of another foldable display panel, in accordance with some embodiments;

FIG. 14 is a plan view of a first buffer layer in FIG. 6;

FIG. 15 is a structural diagram of film layers of a foldable display panel, in accordance with some embodiments;

FIG. 16 is a structural diagram of film layers of another foldable display panel, in accordance with some embodiments;

FIG. 17 is a structural diagram of film layers of another foldable display panel, in accordance with some embodiments;

FIG. 18 is a structural diagram of another foldable display panel, in accordance with some embodiments;

FIG. 19 is a structural diagram of another foldable display panel, in accordance with some embodiments;

FIG. 20 is a structural diagram of film layers of another foldable display panel, in accordance with some embodiments;

FIG. 21 is a structural diagram of film layers of another foldable display panel, in accordance with some embodiments;

FIG. 22 is a structural diagram of film layers of another foldable display panel, in accordance with some embodiments;

FIG. 23 is a structural diagram of a cover plate assembly in FIG. 22;

FIG. 24 is a structural diagram of film layers of another foldable display panel, in accordance with some embodiments;

FIG. 25 is a structural diagram of film layers of another foldable display panel, in accordance with some embodiments;

FIG. 26 is a structural diagram of film layers of another foldable display panel, in accordance with some embodiments;

FIG. 27 is a structural diagram of film layers of another foldable display panel, in accordance with some embodiments;

FIG. 28 is a structural diagram of a cover plate assembly, in accordance with some embodiments; and

FIG. 29 is a structural diagram of another cover plate assembly, in accordance with some embodiments.

### DESCRIPTION OF THE INVENTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics described herein may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, features defined with “first” or “second” may explicitly or implicitly include one or more of the features. In the description of the embodiments of the present disclosure, the term “a plurality of” or “the plurality of” means two or more unless otherwise specified.

In the description of some embodiments, the expressions “coupled” and “connected” and derivatives thereof may be used. The term “connection” should be understood in a broad sense. For example, the “connection” may be a fixed connection, a detachable connection, or of an integrated structure; it may be a direct connection or an indirect connection by an intermediate medium. The term “coupled” indicates, for example, that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the content herein.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term “if” is optionally construed as “when” or “in a case where” or “in response to determining that” or “in response to detecting”, depending on the context. Similarly, the phrase “if it is determined that” or “if [a stated condition or event] is detected” is optionally construed as “in a case where it is determined that” or “in response to determining that” or “in a case where [the stated condition or event] is detected” or “in response to detecting [the stated condition or event]”, depending on the context.

The phrase “applicable to” or “configured to” as used herein indicates an open and inclusive expression, which does not exclude apparatuses that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values exceeding those stated.

The term “about”, “substantially” or “approximately” as used herein includes a stated value and an average value within an acceptable range of deviation of a particular value. The acceptable range of deviation is determined by a person of ordinary skill in the art in consideration of the measurement in question and errors associated with the measurement of a particular quantity (i.e., limitations of the measurement system).

The term such as “parallel”, “perpendicular” or “equal” as used herein includes a stated condition and a condition similar to the stated condition. A range of the similar condition is within an acceptable range of deviation. The acceptable range of deviation is determined by a person of ordinary skill in the art in view of measurement in question and errors associated with the measurement of a particular quantity (i.e., limitations of the measurement system). For example, the term “parallel” includes absolute parallelism and approximate parallelism, and an acceptable range of deviation of the approximate parallelism may be a deviation within 5°; the term “perpendicular” includes absolute perpendicularity and approximate perpendicularity, and an acceptable range of deviation of the approximate perpendicularity may also be a deviation within 5°, and the term “equal” includes absolute equality and approximate equality, and an acceptable range of deviation of the approximate equality may be a difference between two equals being less than or equal to 5% of either of the two equals.

It will be understood that when a layer or element is referred to as being on another layer or substrate, the layer or element may be directly on the another layer or substrate, or there may be intermediate layer(s) between the layer or element and the another layer or substrate.

Exemplary embodiments are described herein with reference to sectional views and/or plane views as idealized exemplary drawings. In the accompanying drawings, thicknesses of layers and sizes of areas/regions are enlarged for clarity. Variations in shapes relative to the accompanying drawings due to, for example, manufacturing technologies and/or tolerances may be envisaged. Therefore, the exemplary embodiments should not be construed to be limited to the shapes of areas/regions shown herein, but to include deviations in the shapes due to, for example, manufacturing. For example, an etched area/region shown in a rectangular shape generally has a feature of being curved. Therefore, the areas/regions shown in the accompanying drawings are schematic in nature, and their shapes are not intended to show actual shapes of the areas/regions in a device, and are not intended to limit the scope of the exemplary embodiments.

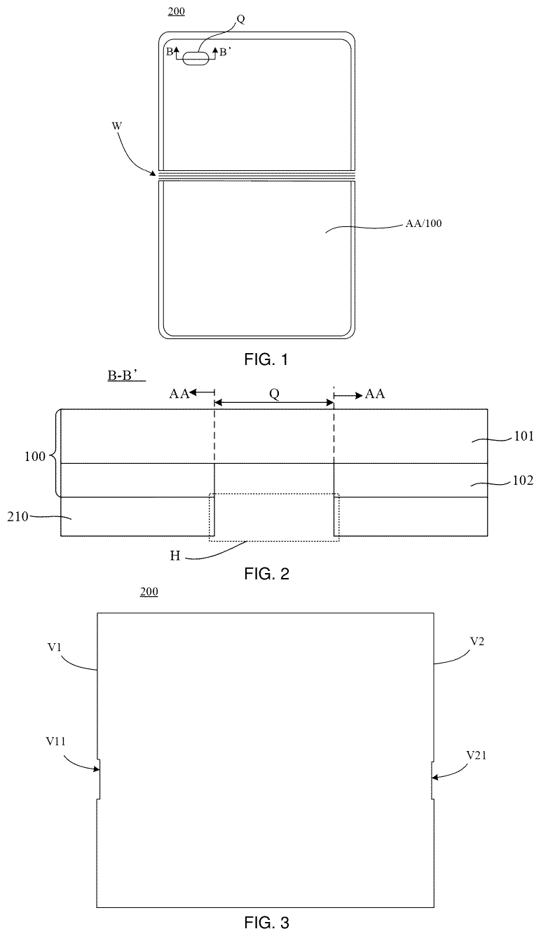

FIG. 1 is a structural diagram of a foldable display apparatus in accordance with some embodiments. With reference to FIG. 1, some embodiments of the present disclosure provide a foldable display apparatus 200, and the foldable display apparatus 200 includes a foldable display panel 100.

For example, the foldable display apparatus 200 further includes a frame and other electronic components.

For example, the foldable display apparatus 200 may be an electroluminescent foldable display apparatus or a photoluminescent foldable display apparatus. In a case where the foldable display apparatus is the electroluminescent foldable display apparatus, the electroluminescent foldable display apparatus may be an organic light-emitting diode (OLED) foldable display apparatus or a quantum dot light-emitting diode (QLED) foldable display apparatus. In a case where the foldable display apparatus is the photoluminescent foldable display apparatus, the photoluminescent foldable display apparatus may be a quantum dot photoluminescent foldable display apparatus.

For example, the foldable display apparatus 200 may be any apparatus that displays images whether in motion (such as a video) or fixed (such as a still image), and regardless of text or image. More specifically, it is expected that the foldable display apparatus in the described embodiments may be implemented in or associated with a variety of electronic devices. The variety of electronic devices may include (but are not limited to), for example, mobile phones, wireless devices, personal digital assistants (PDAs), hand-held or portable computers, global positioning system (GPS) receivers/navigators, cameras, MPEG-4 Part 14 (MP4) video players, video cameras, game consoles, watches, clocks, calculators, TV monitors, flat-panel displays, computer monitors, car displays (e.g., odometer displays), navigators, cockpit controllers and/or displays, camera view displays (e.g., display of rear view camera in vehicles), electronic photos, electronic billboards or signs, projectors, architectural structures, packaging and aesthetic structures (e.g., displays for displaying an image of a piece of jewelry), etc.

FIG. 2 is a cross-sectional view taken along a section line B-B′ in FIG. 1.

In some embodiments, in combination with FIGS. 1 and 2, the foldable display apparatus 200 includes a display area AA (active area, also referred to as active display area). The display area AA includes a light-transmitting area Q. Here, the light-transmitting area Q is at least part of the display area AA in the foldable display panel 100. FIG. 1 shows an example in which the light-transmitting area Q is located at a position of the display area AA away from a lower frame of the foldable display panel 100. It can be understood that in some other embodiments, the light-transmitting area Q may also be located at a position of the display area AA proximate to the lower frame of the foldable display panel 100.

In some examples, with continued reference to FIG. 1, the light-transmitting area Q may be in a shape of an ellipse. However, the shape of the light-transmitting area Q in the embodiments of the present disclosure is not limited thereto. For example, the light-transmitting area Q may be in a shape of a square or a circle.

For example, the light-transmitting area Q is a camera area or a fingerprint recognition area. The description is made below by considering an example where the light-transmitting area Q is the camera area, and the same is applicable to fingerprint recognition.

In some examples, with continued reference to FIG. 1, the foldable display apparatus 200 further includes at least one foldable area W. The foldable area extends from one side of the foldable display apparatus 200 to another side opposite thereto, so as to realize a folding function of the foldable display apparatus 200.

In addition, the above foldable display apparatus 200 is introduced only by taking an example of a single-folding structure, that is, the foldable display apparatus 200 is only folded once, and subsequently, an exposed area of the corresponding foldable display apparatus 200 is reduced by half. However, the present disclosure is not limited thereto. The foldable display apparatus 200 may also be configured as a multi-folding structure, so that the foldable display apparatus 200 is subsequently folded into a structure with a smaller exposed area. The single-folding structure may include one foldable area W, and the multiple-folding structure may include two or more foldable areas W. There is no specific limitation on the specific position(s) of the folding portion(s).

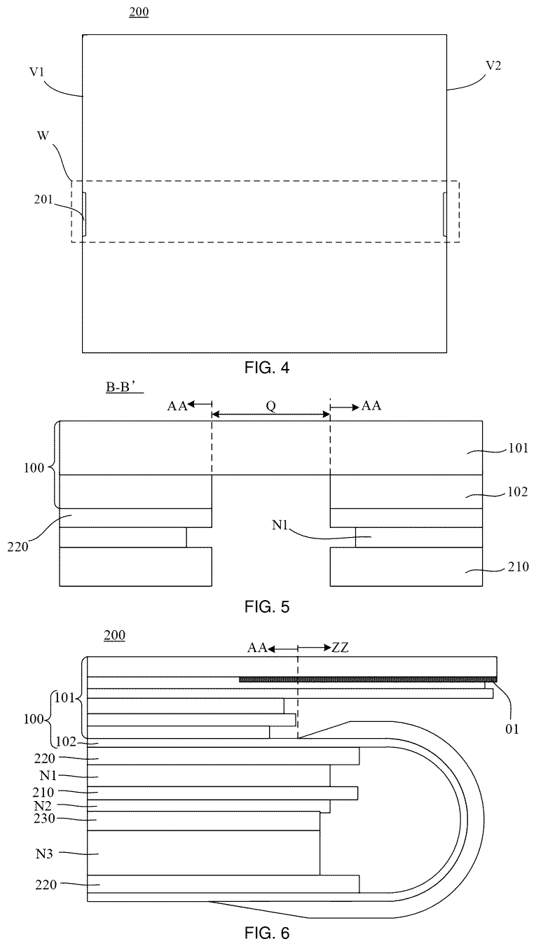

FIG. 3 is a plan view of a foldable display apparatus in accordance with some embodiments. FIG. 4 is a plan view of another foldable display apparatus in accordance with some embodiments.

In some embodiments, in combination with FIGS. 3 and 4, the foldable display apparatus 200 further includes a hinge 201, and the hinge 201 is used to bend the foldable display apparatus 200 in the foldable area W to achieve folding and bending of the foldable display apparatus 200.

Based on this, the foldable display apparatus 200 further includes a first side V1 and a second side V2 that are opposite to each other. The first side V1 includes a first slot V11, and the second side V2 includes a second slot V21. The first slot V11 of the first side V1 and the second slot V21 of the second side V2 are disposed opposite to each other. The hinge 201 is located in the first slot V11 and the second slot V21, and is engaged with the first slot V11 and the second slot V21 to fix the hinge 201.

It will be noted that a plurality of film layers of the cover plate assembly 101 in the foldable display apparatus 200 may all be provided with slots, and the slots of all the film layers, such as a first protective layer, a transparent cover plate and a first buffer layer, may constitute the corresponding first slot V11 and the corresponding second slot V21.

In addition, the foldable display apparatus 200 may also be provided with a volume key slot therein to set the volume key in the foldable display apparatus 200. For example, the volume key slot is located in the first side V1 or the second side V2.

In some embodiments, with reference to FIG. 2, the foldable display panel 100 in the foldable display apparatus 200 includes a cover plate assembly 101 and a display substrate 102. The cover plate assembly 101 is located on a light-exit surface of the display substrate 102, and the cover plate assembly 101 may be used to protect the display substrate 102.

In some examples, referring to FIG. 2, the foldable display apparatus 200 further includes a support plate 210. The support plate 210 is located on a backlight side of the foldable display panel 100, and the support plate 210 includes a light-transmitting hole H. The backlight side of the foldable display panel 100 may be understood as a side opposite to the light-exit side of the foldable display panel 100.

With such a provision, the support plate 210 may support the foldable display panel 100, and image light may be emitted into an under-screen camera through the light-transmitting hole H, thereby realizing a full-screen design of the foldable display apparatus 200.

For example, FIG. 2 illustrates an example in which an edge of an orthogonal projection of the light-transmitting hole H on the cover plate assembly 101 substantially coincides with an edge of an orthogonal projection of the light-transmitting area Q on the cover plate assembly 101. It can be understood that in some other examples, the orthogonal projection of the light-transmitting hole H on the cover plate assembly 101 may cover the orthogonal projection of the light-transmitting area Q on the cover plate assembly 101. Alternatively, in some other examples, the orthogonal projection of the light-transmitting hole H on the cover plate assembly 101 partially overlaps with the orthogonal projection of the light-transmitting area Q on the cover plate assembly 101.

It will be noted that, the description “substantially coincide” includes absolute coincidence and approximate coincidence. That is, an absolute value of an interval between the edge of the orthogonal projection of the light-transmitting hole H on the cover plate assembly 101 and the edge of the orthogonal projection of the light-transmitting area Q on the cover plate assembly 101 does not exceed an error threshold. It can also be considered that the edge of the orthogonal projection of the light-transmitting hole H on the cover plate assembly 101 and the edge of the orthogonal projection of the light-transmitting area Q on the cover plate assembly 101 “coincide” relatively. A ratio of the error threshold to a length of the light-transmitting area Q may be in a range of 1% to 5%, inclusive.

In some examples, referring to FIG. 2, a material of the support plate 210 may be a metal material such as stainless steel SUS, copper or titanium alloy.

For example, the description is made by considering an example where the material of the support plate 210 is stainless steel SUS, the support plate 210 may have relatively good supporting force, so as to play a role of supporting the foldable display panel 100, thereby improving the quality of the foldable display apparatus 200.

In some examples, a thickness of the support plate 210 may be within a range of 80 μm to 200 μm, inclusive. In a case where the thickness of the support plate 210 is within the range of 80 μm to 200 μm, inclusive, not only may the support plate 210 have relatively good supporting force, but also the support plate 210 may be prevented from being too heavy, thereby ensuring the user experience.

For example, the thickness of the support plate 210 is about 80 μm, 100 μm, 120 μm, 150 μm or 200 μm. However, the embodiments of the present disclosure are not limited thereto.

FIG. 5 is another cross-sectional view taken along a section line B-B′ in FIG. 1.

In some embodiments, referring to FIG. 5, the foldable display apparatus 200 further includes a back film (U-film) 220. The back film 220 may be located between the foldable display panel 100 and the support plate 210, and the back film 220 may play a certain supporting role for the foldable display panel 100.

In some embodiments, referring to FIG. 5, the back film 220 may be bonded to the support plate 210 by a first adhesive layer N1. However, the embodiments of the present disclosure are not limited thereto.

In some examples, the first adhesive layer N1 may be a polyimide (PI) double-sided adhesive. The back film 220 and the support plate 210 may be fixed and connected by a polyimide double-sided adhesive to improve the stability of the foldable display apparatus 200.

For example, the polyimide double-sided adhesive may include an adhesive layer, a polyimide layer and an adhesive layer that are stacked. Such a provision may help increase the cohesive force of the polyimide double-sided adhesive to improve the static shear adhesion, so as to well fix and connect the back film 220 and the support plate 210.

FIG. 6 is a structural diagram of another foldable display apparatus in accordance with some embodiments.

In some embodiments, referring to FIG. 6, the foldable display panel 100 in the foldable display apparatus 200 further includes a bending area ZZ, and the bending area ZZ is located on a side of the display area AA (e.g., one side, or all around (i.e., including upper and lower sides and left and right sides)). The following description will be made by considering an example where the bending area ZZ is adjacent to a lower edge of the display area AA.

In some examples, the foldable display panel 100 further includes a bonding area, and the bonding area is located on a side of the bending area ZZ away from the display area AA. The bonding area of the foldable display panel 100 is bent to the backlight side of the foldable display panel 100 through the bending area ZZ, that is, the display substrate 102 is bent at a position of the bending area ZZ. As a result, it may be possible to reduce the structural space of the whole machine and make the whole machine achieve the narrow frame by bending the display panel and a driver chip to the back of the foldable display panel 100.

In some examples, the foldable display apparatus 200 further includes a support block 230, and a material of the support block 230 may be titanium alloy. When the foldable display panel 100 is bent though the bending area ZZ, the support block 230 may be used to support the foldable display panel 100.

In some examples, the foldable display apparatus 200 may further include a double-sided adhesive N2 located between the support block 230 and the support plate 210. The double-sided adhesive N2 may not only be used to fix the support block 230 and the support plate 210, but also play a role in supporting the foldable display panel 100 (the display substrate 102).

In some examples, the double-sided adhesive N2 may be a polyimide (PI) double-sided adhesive. The support block 230 and the support plate 210 may be fixed and connected by a polyimide double-sided adhesive to improve the stability of the foldable display apparatus 200.

For example, the polyimide double-sided adhesive may include an adhesive layer, a polyimide layer and an adhesive layer that are stacked. Such a provision may help increase the cohesive force of the polyimide double-sided adhesive to improve the static shear adhesion, so as to well fix and connect the support block 230 and the support plate 210.

In some examples, the foldable display apparatus 200 may further include a bending spacer N3 located between the support block 230 and the back film 220, and the bending spacer N3 may play a role in supporting the display substrate 102. In addition, the bending spacer N3 may also have stickiness, so that the support block 230 and the back film 220 may be fixed and connected by the bending spacer N3.

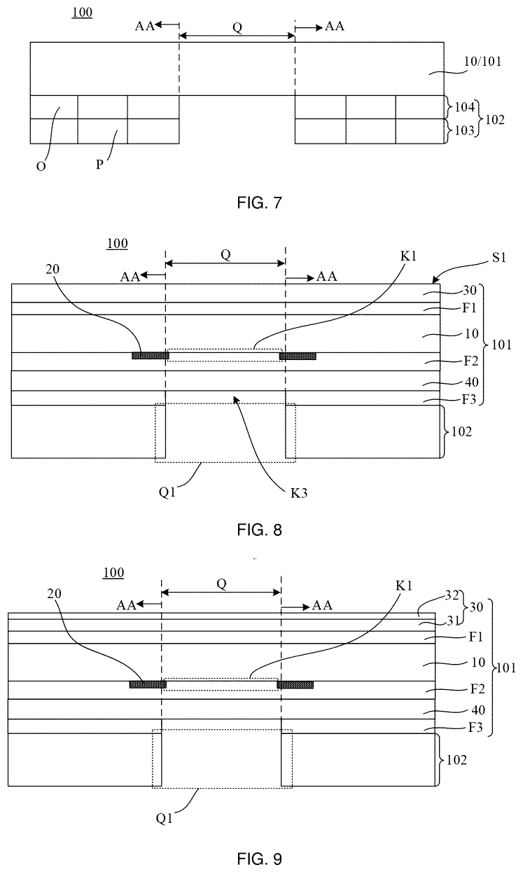

FIG. 7 is a structural diagram of a foldable display panel in accordance with some embodiments. Referring to FIG. 7, some embodiments of the present disclosure provide a foldable display panel 100.

The foldable display panel 100 includes a display area AA (active area, also referred to as active display area). The display area AA includes a light-transmitting area Q. The display area AA and the light-transmitting area Q in the foldable display panel 100 correspond to the display area AA and the light-transmitting area Q in the foldable display apparatus 200. That is, the display area AA in the foldable display panel 100 is the display area AA in the foldable display apparatus 200, and the light-transmitting area Q in the foldable display panel 100 is the light-transmitting area Q in the foldable display apparatus 200.

The foldable display panel 100 further includes a cover plate assembly 101 and a display substrate 102. The cover plate assembly 101 is located on a light-exit side of the display substrate 102. A transparent cover plate 10 is located on the light-exit side of the display substrate 102, and the transparent cover plate 10 in the cover plate assembly 101 may play a role in protecting the display substrate 102.

In some examples, the display substrate 102 may include an array substrate 103 and a light-emitting device layer 104. The array substrate 103 may include a plurality of pixel driving circuits P. The light-emitting device layer 104 is located on a side of the array substrate 103 proximate to the transparent cover plate 10. The light-emitting device layer 104 includes a plurality of light-emitting devices O. The light-emitting device O is electrically connected to the pixel driving circuit P in the array substrate 103.

In some examples, the light-emitting device O includes an anode layer, a light-emitting layer and a cathode layer that are sequentially stacked. In some examples, an electron transport layer is further provided between the cathode layer and the light-emitting layer, and a hole transport layer is further provided between the anode layer and the light-emitting layer.

For example, the above light-emitting devices O may be OLED light-emitting devices, but are not limited thereto. The embodiments of the present disclosure do not limit the type of light-emitting devices, that is, the light-emitting devices O may be any other light-emitting devices (e.g., light-emitting devices that emit light by discharge), as long as they can emit light so that the foldable display panel 100 may display a picture. For example, the light-emitting devices O may be mini-LEDs and/or micro-LEDs.

In some examples, the plurality of pixel driving circuits P and the plurality of light-emitting devices O may be coupled in one-to-one correspondence. In some other examples, a pixel driving circuit P may be coupled to multiple light-emitting devices O, or multiple pixel driving circuits P may be coupled to a light-emitting device O. Hereinafter, the structure of the foldable display pane 100 will be exemplarily described in the embodiments of the present disclosure by considering an example of a pixel driving circuit P being coupled to a light-emitting device O.

FIG. 8 is a structural diagram of another foldable display panel in accordance with some embodiments.

In some embodiments, referring to FIG. 8, the cover plate assembly 101 includes a transparent cover plate 10. The transparent cover plate 10 is located on the light-exit side of the display substrate 102. The transparent cover plate 10 in the cover plate assembly 101 may play a role in protecting the display substrate 102.

In some embodiments, with continued reference to FIG. 8, a material of the transparent cover plate 10 includes ultra-thin glass (UTG). The ultra-thin glass may be bent, curled or folded, thereby facilitating the folding of the flexible display panel. Moreover, a thickness of the ultra-thin glass is much thinner than that of ordinary glass, so that the thickness of the cover plate assembly 101 may be reduced, thereby facilitating miniaturization of the device.

Based on this, it is beneficial for improving foldability, durability and reliability of the cover plate assembly 101.

In some examples, the elastic modulus of the transparent cover plate 10 is in a range of 70 GPa to 80 GPa, inclusive. In a case where the elastic modulus of the transparent cover plate 10 is within the range of 70 GPa to 80 GPa, inclusive, the transparent cover plate 10 not only meets the bendability requirements of the foldable display panel 100, but also has relatively high hardness to protect the display substrate 102.

For example, the elastic modulus of the transparent cover plate 10 is approximately 70 GPa, 72 GPa, 74 GPa, 76 GPa, 78 GPa or 80 GPa.

The description is made by considering an example where the elastic modulus of the transparent cover plate 10 is about 74 GPa, and the transparent cover plate 10 not only meets the bendability requirements of the foldable display panel 100, but also has relatively high hardness to protect the display substrate 102.

It will be noted that due to certain uncontrollable errors (e.g., manufacturing process error, equipment accuracy, and measurement error), in a case where a floating range of error of the elastic modulus of the transparent cover plate 10 is within −10%×74 GPa to 10%×74 GPa, it may be considered that the elastic modulus of the transparent cover plate 10 is equal to 74 GPa.

In addition, in some other examples, due to certain uncontrollable errors (e.g., manufacturing process error, equipment accuracy, and measurement error), in a case where a floating range of error of the elastic modulus of the transparent cover plate 10 is within −5%×74 GPa to 5%×74 GPa, it may be considered that the elastic modulus of the transparent cover plate 10 is equal to 74 GPa.

It will be noted that the “range” mentioned below includes two endpoint values of the corresponding range.

In some examples, a thickness of the transparent cover plate 10 is in a range of 25 μm to 70 μm, inclusive.

In a case where the thickness of the transparent cover plate 10 is equal to or close to 25 μm, the thickness of the transparent cover plate 10 may be made relatively thin, which is conducive to bending of the foldable display panel 100. Moreover, the transparent cover plate 10 has a certain hardness, which may protect the display substrate 102 and meet the clarity requirements of the transparent cover plate 10 in the foldable display panel 100.

In a case where the thickness of the transparent cover plate 10 is equal to or close to 70 μm, the transparent cover plate 10 may be made relatively thick, which is conducive to making the transparent cover plate 10 have high hardness and good glass texture, so that the transparent cover plate 10 has high clarity and achieves the effect of long-term protection of the display substrate 102. Moreover, the transparent cover plate 10 also has a certain flexibility to meet the bendability requirements of the transparent cover plate 10 in the foldable display panel 100.

In some other examples, a thickness of the transparent cover plate 10 is in a range of 30 μm to 50 μm, inclusive.

In a case where the thickness of the transparent cover plate 10 is equal to or close to 30 μm, the transparent cover plate 10 may have a relatively good bending effect. Moreover, the transparent cover plate 10 has a certain hardness, which may protect the display substrate 102 and meet the clarity requirements of the transparent cover plate 10 in the foldable display panel 100.

In a case where the thickness of the transparent cover plate 10 is equal to or close to 50 μm, the transparent cover plate 10 may have relatively high hardness and relatively good glass texture, so that the transparent cover plate 10 has relatively high clarity and achieves the effect of long-term protection of the display substrate 102. Moreover, the transparent cover plate 10 also has a certain flexibility to meet the bendability requirements of the transparent cover plate 10 in the foldable display panel 100.

In some embodiments, with continued reference to FIG. 8, the thickness of the transparent cover plate 10 is approximately 25 μm, 30 μm, 40 μm or 50 μm.

The description is made by considering an example where the thickness of the transparent cover plate 10 is approximately 50 μm. In a case where the thickness of the transparent cover plate 10 is approximately 50 μm, the transparent cover plate 10 may not only meet the clarity requirements of the transparent cover plate 10 in the foldable display panel 100, but also have a certain hardness and a certain flexibility, so as to meet the bendability requirements of the transparent cover plate 10 in the foldable display panel 100 and play a role in protecting the display substrate 102.

It will be noted that due to certain uncontrollable errors (e.g., manufacturing process error, equipment accuracy, and measurement error), in a case where a floating range of error of the thickness of the transparent cover plate 10 is within −10%×50 μm to 10%×50 μm, it may be considered that the thickness of the transparent cover plate 10 is equal to 50 μm.

In addition, in some other examples, due to certain uncontrollable errors (e.g., manufacturing process error, equipment accuracy, and measurement error), in a case where a floating range of error of the thickness of the transparent cover plate 10 is within −5%×50 μm to 5%×50 μm, it may be considered that the thickness of the transparent cover plate 10 is equal to 50 μm.

However, the thickness of the transparent cover plate 10 in the embodiments of the present disclosure is not limited thereto. In some other embodiments, the cover plate assembly 101 may further include other film layers. In this case, the thickness of the transparent cover plate 10 may be changed depending on the specific structure of the cover plate assembly 101. The structure of the cover plate assembly 101 will be described in conjunction with the accompanying drawings below.

Since a surface strength of the transparent cover plate 10 in the cover plate assembly 101 is insufficient, the transparent cover plate 10 is prone to cracking when the foldable display panel 100 is bent.

Based on the above problems, in some embodiments, referring to FIG. 8, the cover plate assembly 101 in the foldable display panel 100 may further include a first protective layer 30, and the first protective layer 30 is located on a side of the transparent cover plate 10 away from the display substrate 102.

Based on this, the first protective layer 30 may be used to cover the transparent cover plate 10, so that the first protective layer 30 may play a role in protecting the transparent cover plate 10, and the cover plate assembly 101 may have rather high hardness and rather good impact resistance.

In some embodiments, an elastic modulus of the first protective layer 30 is in a range of 3.5 GPa to 7 GPa, inclusive.

In a case where the elastic modulus of the first protective layer 30 is equal to or close to 3.5 GPa, the first protective layer 30 may meet the bending requirements of the foldable display panel 100, and the first protective layer 30 also has relatively good impact resistance, thereby playing a role in protecting the display substrate 102.

In a case where the elastic modulus of the first protective layer 30 is equal to or close to 7 GPa, the first protective layer 30 may have rather good buffering and recovery properties, so that the first protective layer 30 may have rather good impact resistance to well protect the display substrate 102. Moreover, the bending of the foldable display panel 100 may not be affected caused by an excessively large elastic modulus of the first protective layer 30.

In some examples, the elastic modulus of the first protective layer 30 is in a range of 5.5 GPa to 7.5 GPa, inclusive.

In a case where the elastic modulus of the first protective layer 30 is equal to or close to 5.5 GPa, the first protective layer 30 may have relatively good buffering and recovery properties, so that the first protective layer 30 may have relatively good impact resistance without affecting the bending requirements of the foldable display panel 100.

In a case where the elastic modulus of the first protective layer 30 is equal to or close to 7.5 GPa, the first protective layer 30 may have rather good buffering and recovery properties, so that the first protective layer 30 may have rather good impact resistance. Moreover, the bending of the foldable display panel 100 may not be affected caused by an excessively large elastic modulus of the first protective layer 30.

For example, the elastic modulus of the first protective layer 30 is approximately 5.5 GPa, 6 GPa, 6.2 GPa, 6.5 GPa, 6.8 GPa, 7 GPa or 7.5 GPa.

It will be noted that the explanation is made by considering an example where the elastic modulus of the first protective layer 30 is approximately 6.2 GPa. Due to certain uncontrollable errors (e.g., manufacturing process error, equipment accuracy, and measurement error), in a case where a floating range of error of the elastic modulus of the first protective layer 30 is within −10%×6.2 GPa to 10%×6.2 GPa, it may be considered that the elastic modulus of the first protective layer 30 is equal to 6.2 GPa.

In addition, in some other examples, due to certain uncontrollable errors (e.g., manufacturing process error, equipment accuracy, and measurement error), in a case where a floating range of error of the elastic modulus of the first protective layer 30 is within −5%×6.2 GPa to 5%×6.2 GPa, it may be considered that the elastic modulus of the first protective layer 30 is equal to 6.2 GPa.

FIG. 9 is a structural diagram of another foldable display panel in accordance with some embodiments.

In some embodiments, with continued reference to FIG. 9, the first protective layer 30 includes a protective substrate 31, and a material of the protective substrate 31 includes transparent polyimide (colorless polyimide, CPI).

The transparent polyimide is formed on a side of the transparent cover plate 10 away from the display substrate 102, and the transparent polyimide is used as an impact-resistant layer to disperse impact stress, so as to play a role in protecting the transparent cover plate 10, thereby preventing the transparent cover plate 10 from being broken when the foldable display panel 100 is impacted by external force.

In addition, in a case where transparent polyimide is used to form the protective substrate 31, the elastic modulus of the first protective layer 30 may be made approximately 6.2 GPa, so that the first protective layer 30 may have relatively large elastic modulus, and thus the first protective layer 30 may have relatively good impact resistance.

The foldable display apparatuses 200 include an inward foldable display apparatus 200 and an outward foldable display apparatus 200. The difference between the inward foldable display apparatus 200 and the outward foldable display apparatus 200 lies in a direction in which the display apparatus 200 is folded. For the inward foldable display apparatus 200, the foldable display apparatus 200 is folded inwardly, that is, the foldable display panel 100 is located on an inner side of the support plate. For the outward foldable display apparatus 200, the foldable display apparatus 200 is folded outwardly, that is, the foldable display panel 100 is located on an outer side of the support plate.

During manufacturing the outward foldable display apparatus 200, since the transparent cover plate 10 and the display substrate 102 are located on the outer side of the support plate, the transparent cover plate 10 and the display substrate 102 will be directly subjected to force when subjected to external force impact, and are prone to scratches due to long-term exposure to the environment.

Based on this, the first protective layer 30 with a relatively large elastic modulus (6 GPa to 7 GPa) may be located on the outer side of the transparent cover plate 10, the display substrate 102 and other structural film layers. That is, the first protective layer 30 is used as the outermost film layer of the outward display apparatus 200. The first protective layer 30 may effectively disperse the impact stress to well protect the transparent cover plate 10, the display substrate 102 and other structural film layers, thereby preventing the transparent cover plate 10, the display substrate 102 and other structural film layers from being broken, and preventing the transparent cover plate 10 and the display substrate 102 from being scratched.

During manufacturing the inward display apparatus 200, since the transparent cover plate 10, the display substrate 102 and other structural film layers are all located on the inner side of the support plate, the transparent cover plate 10, the display substrate 102 and other structural film layers will not be directly subjected to force, and the probability of cracking is relatively low.

Based on this, the requirement for the elastic modulus of the first protective layer 30 is not as strict as that of the outward foldable display apparatus 200, and the first protective layer 30 with an elastic modulus in the above range of 3.5 GPa to 7 GPa may be used. The transparent polyimide may be used as an impact-resistant layer to disperse the impact stress, so as to play a role in protecting the transparent cover plate 10, thereby preventing the transparent cover plate 10 from being broken when the foldable display panel 100 is impacted by external force.

In summary, the first protective layer 30 with a relatively large elastic modulus may also make the structure more suitable for the outward foldable display panel 100.

It will be noted that due to certain uncontrollable errors (e.g., manufacturing process error, equipment accuracy, and measurement error), in a case where a floating range of error of the elastic modulus of the first protective layer 30 is within −10%×6.2 GPa to 10%×6.2 GPa, it may be considered that the elastic modulus of the first protective layer 30 is equal to 6.2 GPa.

In addition, in some other examples, due to certain uncontrollable errors (e.g., manufacturing process error, equipment accuracy, and measurement error), in a case where a floating range of error of the elastic modulus of the first protective layer 30 is within −5%×6.2 GPa to 5%×6.2 GPa, it may be considered that the elastic modulus of the first protective layer 30 is equal to 6.2 GPa.

In some examples, a thickness of the protective substrate 31 (transparent polyimide) is in a range of 50 μm to 80 μm, inclusive.

In a case where the thickness of the protective substrate 31 (transparent polyimide) is equal to or close to 50 μm, the protective substrate 31 has a relatively small thickness, so that the first protective layer 30 is prone to bending, which is conducive to lightness and thinness of the foldable display panel 100.

In a case where the thickness of the protective substrate 31 (transparent polyimide) is equal to or close to 80 μm, the protective substrate 31 has a relatively large thickness, so that the first protective layer 30 may have relatively good impact resistance to disperse the impact stress, so as to play a role in protecting the transparent cover plate 10, thereby preventing the transparent cover plate 10 from being broken when the foldable display panel 100 is impacted by external force.

In some other examples, a thickness of the protective substrate 31 (transparent polyimide) is in a range of 70 μm to 80 μm, inclusive.

In a case where the thickness of the protective substrate 31 (transparent polyimide) is equal to or close to 70 μm, the first protective layer 30 is prone to bending, which is conducive to lightness and thinness of the foldable display panel 100.

In a case where the thickness of the protective substrate 31 (transparent polyimide) is equal to or close to 80 μm, the first protective layer 30 may have relatively good impact resistance to prevent the transparent cover plate 10 from being broken when the foldable display panel 100 is impacted by external force. Moreover, the first protective layer 30 may meet the bendability requirements of the foldable display panel 100 to be suitable for folding the foldable display panel. The foldable display panel may be an inward foldable display panel or an outward foldable display panel.

Since the transparent polyimide has a relatively large elastic modulus, a relatively good impact resistance, and a relatively good wear resistance, the first protective layer 30 formed based on the transparent polyimide is more suitable for an outward foldable display panel. However, the embodiments of the present disclosure are not limited thereto.

In some embodiments, with continued reference to FIG. 9, the thickness of the protective substrate 31 (transparent polyimide) is approximately 50 μm, 60 μm, 70 μm or 80 μm.

It will be noted that the explanation is made by considering an example where the thickness of the protective substrate 31 (transparent polyimide) is approximately 80 μm. Due to certain uncontrollable errors (e.g., manufacturing process error, equipment accuracy, and measurement error), in a case where a floating range of error of the thickness of the protective substrate 31 (transparent polyimide) is within −10%×80 μm to 10%×80 μm, it may be considered that the thickness of the protective substrate 31 (transparent polyimide) is equal to 80 μm.

In addition, in some other examples, due to certain uncontrollable errors (e.g., manufacturing process error, equipment accuracy, and measurement error), in a case where a floating range of error of the thickness of the protective substrate 31 (transparent polyimide) is within −5%×80 μm to 5%×80 μm, it may be considered that the thickness of the protective substrate 31 (transparent polyimide) is equal to 80 μm.

The first protective layer 30 with the protective substrate 31 having a material of transparent polyimide (colorless polyimide, CPI) is described above in conjunction with the relevant drawings. However, the material of the protective substrate 31 in the embodiments of the present disclosure is not limited thereto. It can be understood that in some other embodiments, the material of the protective substrate 31 may be polyethylene terephthalate (PET).

Both the material of transparent polyimide CPI and the material of polyethylene terephthalate PET have high transparency, and thus the first protective layer 30 formed based on this may be prevented from affecting the light transmittance of the foldable display panel 100.

In some embodiments, an elastic modulus of polyethylene terephthalate (PET) is in a range of 3.5 GPa to 4.5 GPa, inclusive.

In a case where the elastic modulus of the polyethylene terephthalate (PET) is equal to or close to 3.5 GPa, the first protective layer 30 (polyethylene terephthalate (PET)) may meet the bending requirements of the foldable display panel 100, and the first protective layer 30 (polyethylene terephthalate (PET)) also has relatively good impact resistance, thereby playing a role in protecting the display substrate 102.

In a case where the elastic modulus of the first protective layer 30 is equal to or close to 4.5 GPa, the first protective layer 30 (polyethylene terephthalate (PET)) may have rather good buffering and recovery properties, so that the first protective layer 30 (polyethylene terephthalate (PET)) may have rather good impact resistance to well protect the display substrate 102. Moreover, the bending of the foldable display panel 100 may not be affected caused by an excessively large elastic modulus of the first protective layer 30 (polyethylene terephthalate (PET)).

In some examples, the elastic modulus of polyethylene terephthalate (PET) is approximately 3.5 GPa, 3.8 GPa, 4 GPa, 4.2 GPa or 4.5 GPa. However, the embodiments of the present disclosure are not limited thereto.

The description is made by considering an example where the elastic modulus of the first protective layer 30 (polyethylene terephthalate (PET)) is approximately 4 GPa. Based on this, the first protective layer 30 formed using polyethylene terephthalate will not have an excessively large elastic modulus, and the structure may be more suitable for an inward foldable display panel 100.

It will be noted that due to certain uncontrollable errors (e.g., manufacturing process error, equipment accuracy, and measurement error), in a case where a floating range of error of the elastic modulus of the protective substrate 31 is within −10%×4 GPa to 10%×4 GPa, it may be considered that the elastic modulus of the protective substrate 31 is equal to 4 GPa.

In addition, in some other examples, due to certain uncontrollable errors (e.g., manufacturing process error, equipment accuracy, and measurement error), in a case where a floating range of error of the elastic modulus of the protective substrate 31 is within −5%×4 GPa to 5%×4 GPa, it may be considered that the elastic modulus of the protective substrate 31 is equal to 4 GPa.

In some examples, a thickness of the protective substrate 31 (polyethylene terephthalate) is in a range of 20 μm to 100 μm, inclusive.

In a case where the thickness of the protective substrate 31 (polyethylene terephthalate) is equal to or close to 20 μm, the protective substrate 31 has a relatively small thickness, so that the first protective layer 30 is prone to bending and is conducive to lightness and thinness of the foldable display panel 100.

In a case where the thickness of the protective substrate 31 (polyethylene terephthalate) is equal to or close to 100 μm, the protective substrate 31 has a relatively large thickness, so that the first protective layer 30 may have relatively good impact resistance to disperse the impact stress, so as to play a role in protecting the transparent cover plate 10, thereby preventing the transparent cover plate 10 from being broken when the foldable display panel 100 is impacted by external force.

In some other examples, a thickness of the protective substrate 31 (polyethylene terephthalate) is in a range of 40 μm to 80 μm, inclusive.

In a case where the thickness of the protective substrate 31 (transparent polyimide) is equal to or close to 40 μm, the first protective layer 30 is prone to bending, which is conducive to lightness and thinness of the foldable display panel 100.

In a case where the thickness of the protective substrate 31 (transparent polyimide) is equal to or close to 80 μm, the first protective layer 30 may have relatively good impact resistance to prevent the transparent cover plate 10 from being broken when the foldable display panel 100 is impacted by external force. Moreover, the first protective layer 30 may meet the bendability requirements of the foldable display panel 100 to be suitable for folding the foldable display panel. The foldable display panel may be an inward foldable display panel or an outward foldable display panel.

In some embodiments, with continued reference to FIG. 9, the thickness of the protective substrate 31 (polyethylene terephthalate) is approximately 20 μm, 30 μm, 40 μm, 50 μm, 60 μm, 65 μm, 70 μm, 80 μm, 90 μm or 100 μm.

It will be noted that the explanation is made by considering an example where the thickness of the protective substrate 31 (polyethylene terephthalate) is approximately 65 μm. Due to certain uncontrollable errors (e.g., manufacturing process error, equipment accuracy, and measurement error), in a case where a floating range of error of the thickness of the protective substrate 31 (polyethylene terephthalate) is within −10%×65 μm to 10%×65 μm, it may be considered that the thickness of the protective substrate 31 (polyethylene terephthalate) is equal to 65 μm.

In addition, in some other examples, due to certain uncontrollable errors (e.g., manufacturing process error, equipment accuracy, and measurement error), in a case where a floating range of error of the thickness of the protective substrate 31 (polyethylene terephthalate) is within −5%×65 μm to 5%×65 μm, it may be considered that the thickness of the protective substrate 31 (polyethylene terephthalate) is equal to 65 μm.

The thickness of the protective substrate 31 (polyethylene terephthalate) is set to be approximately 65 μm. As a result, the first protective layer 30 may not only have a certain impact resistance, but also have a certain flexibility, so that the first protective layer 30 may protect the transparent cover plate 10 and meeting the bendability requirements of the foldable display panel 100.

In addition, since a protective substrate 31 (polyethylene terephthalate) with a thickness of about 65 μm may enable the thickness of the first protective layer 30 thin, and the first protective layer 30 may be made more suitable for the inward foldable display panel 100. However, the embodiments of the present disclosure are not limited thereto.

In some embodiments, with continued reference to FIG. 9, the first protective layer 30 may further includes a hard coating (HC) 32 formed on a side of the protective substrate 31 away from the display substrate 102. The hard coating 32 may be used to enhance the surface hardness of the first protective layer 30 away from the display substrate 102, which is beneficial to improving the surface hardness of the first protective layer 30 away from the display substrate 102, so as to improve the hardness of the cover plate assembly 101 in the foldable display panel 100 and improve the reliability of the cover plate assembly 101.

In some examples, a thickness of the hard coating 32 is in a range of 5 μm to 20 μm, inclusive.

In a case where the thickness of the hard coating 32 is equal to or close to 5 μm, the hard coating 32 has a relatively small thickness, so that the first protective layer 30 may have a relatively high hardness while meeting the requirements of bendability.

In a case where the thickness of the hard coating 32 is equal to or close to 20 μm, the hard coating 32 has a relatively large thickness, so that the first protective layer 30 may have a rather high hardness, so as to well protect the transparent cover plate 10 and also enable the first protective layer 30 to meet the requirements of bendability.

In some other examples, a thickness of the hard coating 32 is in a range of 5 μm to 10 μm, inclusive.

In a case where the thickness of the hard coating 32 is equal to or close to 5 μm, the first protective layer 30 may have a relatively high hardness while meeting the requirements of bendability.

In a case where the thickness of the hard coating 32 is equal to or close to 10 μm, the first protective layer 30 may have a rather high hardness, so as to well protect the transparent cover plate 10 and also enable the first protective layer 30 to meet the requirements of bendability. In addition, in the case where the thickness of the hard coating 32 is equal to or close to 10 μm, it may prevent the existing process from being difficult to implement due to the excessive thickness of the hard coating 32, and avoid the uneven surface of the hard coating 32 that is prone to formation during forming the hard coating 32.

For example, the thickness of the hard coating 32 is approximately 5 μm, 6 μm, 7 μm, 8 μm, 9 μm or 10 μm.

It will be noted that the explanation is made by considering an example where the thickness of the hard coating 32 is approximately 5 μm. Due to certain uncontrollable errors (e.g., manufacturing process error, equipment accuracy, and measurement error), in a case where a floating range of error of the thickness of the hard coating 32 is within −10%×5 μm to 10%×5 μm, it may be considered that the thickness of the hard coating 32 is equal to 5 μm.

In addition, in some other examples, due to certain uncontrollable errors (e.g., manufacturing process error, equipment accuracy, and measurement error), in a case where a floating range of error of the thickness of the hard coating 32 is within −5%×5 μm to 5%×5 μm, it may be considered that the thickness of the hard coating 32 is equal to 5 μm.

In some embodiments, in a case where the material of the protective substrate 31 in the first protective layer 30 is transparent polyimide, the thickness of the hard coating 32 is approximately 9 μm.

For example, the thickness of the protective substrate 31 (transparent polyimide) is approximately 80 μm, and the thickness of the hard coating 32 is approximately 9 μm. In this case, the first protective layer 30 may have a relatively good impact resistance and a relatively good wear resistance. Based on this, the first protective layer 30 is more suitable for an outward foldable display panel. However, the embodiments of the present disclosure are not limited thereto.

In some embodiments, in a case where the material of the protective substrate 31 in the first protective layer 30 is polyethylene terephthalate, the thickness of the hard coating 32 is approximately 5 μm.

For example, the thickness of the protective substrate 31 (polyethylene terephthalate) is approximately 650 μm, and the thickness of the hard coating 32 is approximately 5 μm. In this case, the first protective layer 30 may have a relatively good impact resistance to prevent the transparent cover plate 10 from being broken when the foldable display panel 100 is impacted by external force. Moreover, the thickness of the first protective layer 30 is rather thin, and the first protective layer 30 may be more suitable for the inward foldable display panel 100. However, the embodiments of the present disclosure are not limited thereto.

In some embodiments, with continued reference to FIG. 8, the cover plate assembly 101 in the foldable display panel 100 may further include a first buffer layer 40. The first buffer layer 40 is located on a side of the transparent cover plate 10 proximate to the display substrate 102, that is, the transparent cover plate 10 is located between the first protective layer 30 and the first buffer layer 40.

Since the first buffer layer 40 has relatively good buffering and recovery properties, the first buffer layer 40 may play a good role in buffering and shock absorption. In addition, the first buffer layer 40 may effectively absorb part of the bending stress, so as to play a role in protecting the transparent cover plate 10 to a certain extent, thereby preventing the transparent cover plate 10 from being broken when the foldable display panel 100 is impacted by external force.

That is, the transparent cover plate 10 is sandwiched between the first protective layer 30 and the first buffer layer 40, so that the first protective layer 30 and the first buffer layer 40 may be used to protect the transparent cover plate 10, thereby preventing the transparent cover plate 10 from being broken.

In some examples, the first protective layer 30 is closer to an outside of the foldable display panel 100 than the transparent cover plate 10 and the first buffer layer 40. Furthermore, when the foldable display panel 100 is impacted by the external force, the impact force on the first protective layer 30 is the greatest among them.

Furthermore, a material of the first buffer layer 40 may be different from the material of the first protective layer 30, so that the elastic modulus of the first protective layer 30 is greater than the elastic modulus of the first buffer layer 40.

Based on this, the first protective layer 30 with a relatively large elastic modulus is disposed on the outer side of the foldable display panel 100, and the first buffer layer 40 with a relatively small elastic modulus is disposed on the inner side of the foldable display panel 100. The first protective layer 30 with a relatively large elastic modulus may be impacted first, and the first protective layer may play a good role in buffering and shock absorption by utilizing its good impact resistance, so as to prevent the transparent cover plate 10 from being broken. Moreover, the first buffer layer 40 may also be used to simultaneously play a role in buffering and shock absorption and effectively absorb part of the bending stress, so as to also play a role in protecting the transparent cover plate 10 to a certain extent.

In some examples, a material of the buffer layer 40 may be polyethylene terephthalate (PET). Based on this, the elastic modulus of the first buffer layer 40 is in a range of 3.5 GPa to 4.5 GPa, inclusive. That is, the elastic modulus of the first buffer layer 40 is approximately 4 GPa. The first buffer layer 40 has a relatively high elastic modulus. The first buffer layer 40 may have relatively good buffering and recovery properties and may effectively absorb part of the bending stress, thereby playing a good role in buffering and shock absorption.

In some examples, a thickness of the first buffer layer 40 is in a range of 20 μm to 100 μm, inclusive.

In a case where the thickness of the first buffer layer 40 is equal to or close to 20 μm, the first buffer layer 40 has a relatively small thickness, so that the first buffer layer 40 is prone to bending and is conducive to lightness and thinness of the foldable display panel 100.

In a case where the thickness of the first buffer layer 40 is equal to or close to 100 μm, the first buffer layer 40 has a relatively large thickness, so that the first buffer layer 40 may have relatively good impact resistance to disperse the impact stress, so as to play a role in protecting the transparent cover plate 10, thereby preventing the transparent cover plate 10 from being broken when the foldable display panel 100 is impacted by external force.

In some other examples, a thickness of the first buffer layer 40 is in a range of 20 μm to 50 μm, inclusive.

In a case where the thickness of the first buffer layer 40 is equal to or close to 20 μm, the first buffer layer 40 is prone to bending and is conducive to lightness and thinness of the foldable display panel 100.

In a case where the thickness of the first buffer layer 40 is equal to or close to 50 μm, the first buffer layer 40 may have relatively good impact resistance to prevent the transparent cover plate 10 from being broken when the foldable display panel 100 is impacted by external force.

In some embodiments, with continued reference to FIG. 8, the thickness of the first buffer layer 40 is approximately 20 μm, 23 μm, 25 μm, 30 μm, 40 μm, 50 μm, 60 μm, 65 μm, 70 μm, 80 μm, 90 μm or 100 μm.

The explanation is made by considering an example where the thickness of the first buffer layer 40 is approximately 23 μm. Based on this, the first buffer layer 40 may not affect the bending of the foldable display panel 100 due to excessive thickness, and may also effectively disperse the impact stress to protect the transparent cover plate 10.

It will be noted that due to certain uncontrollable errors (e.g., manufacturing process error, equipment accuracy, and measurement error), in a case where a floating range of error of the thickness of the first buffer layer 40 is within −10%×23 μm to 10%×23 μm, it may be considered that the thickness of the first buffer layer 40 is equal to 23 μm.

In addition, in some other examples, due to certain uncontrollable errors (e.g., manufacturing process error, equipment accuracy, and measurement error), in a case where a floating range of error of the thickness of the first buffer layer 40 is within −5%×23 μm to 5%×23 μm, it may be considered that the thickness of the first buffer layer 40 is equal to 23 μm.

In some embodiments, referring to FIG. 8, the cover plate assembly 101 in the foldable display panel 100 may further include a plurality of adhesive layers, and the adhesive layers are each provided in two adjacent film layers in the cover plate assembly 101 to fix the two film layers. An adhesive layer in the plurality of adhesive layers may be a first adhesive layer F1, and the first adhesive layer F1 is located between the first protective layer 30 and the transparent cover plate 10, so that the first adhesive layer F1 is used to fix and bond the first protective layer 30 and the transparent cover plate 10 to improve the stability of the cover plate assembly 101.

In some examples, a material of the first adhesive layer F1 may be an optically clear adhesive (OCA). Since the optically clear adhesive (OCA) has a certain stickiness, the optically clear adhesive (OCA) may fix and connect the first protective layer 30 and the transparent cover plate 10 to improve the stability of the cover plate assembly 101. In addition, since the optically clear adhesive (OCA) has a relatively soft texture and a certain elasticity, the optically clear adhesive (OCA) may effectively absorb part of the bending stress and may also play a role in protecting the transparent cover plate 10 to a certain extent, thereby preventing the transparent cover plate 10 from being broken when the foldable display panel 100 is impacted by external force.

In some embodiments, a thickness of the first adhesive layer F1 is in a range of 15 μm to 100 μm, inclusive.

In a case where the thickness of the first adhesive layer F1 is equal to or close to 15 μm, the first adhesive layer F1 has a relatively small thickness, so as to meet the requirements of adhesive strength of the first adhesive layer F1 and further be beneficial to lightness and thinness of the cover plate assembly 101, that is, be beneficial to lightness and thinness of the foldable display panel 100. In addition, since the first adhesive layer F1 has a relatively small thickness, and the first adhesive layer F1 (optically clear adhesive (OCA)) has a relatively soft texture, thereby preventing the cover plate assembly 101 from being too soft caused by the first adhesive layer F1.

In a case where the thickness of the first adhesive layer F1 is equal to or close to 100 μm, the first adhesive layer F1 has a relatively large thickness, which is beneficial to improving the adhesive strength of the first adhesive layer F1, so as to well fix the transparent cover plate 10 and the first protective layer 30. In addition, since the first adhesive layer F1 has a relatively large thickness, the first adhesive layer F1 may also be used to absorb the bending stress, thereby playing a role in protecting the transparent cover plate 10.

In some examples, a thickness of the first adhesive layer F1 is in a range of 30 μm to 80 μm, inclusive.

In a case where the thickness of the first adhesive layer F1 is equal to or close to 30 μm, the requirements of adhesive strength of the first adhesive layer F1 may be met, and it is also beneficial to lightness and thinness of the cover plate assembly 101, that is, beneficial to lightness and thinness of the foldable display panel 100. In addition, since the first adhesive layer F1 (optically clear adhesive (OCA)) has a relatively soft texture, thereby preventing the cover plate assembly 101 from being too soft caused by the first adhesive layer F1.

In a case where the thickness of the first adhesive layer F1 is equal to or close to 80 μm, it is beneficial to improving the adhesive strength of the first adhesive layer F1, so as to well fix the transparent cover plate 10 and the first protective layer 30. In addition, the first adhesive layer F1 may also be used to absorb the bending stress, thereby playing a role in protecting the transparent cover plate 10.

For example, the thickness of the first adhesive layer F1 is approximately 15 μm, 20 μm, 30 μm, 40 μm, 50 μm, 60 μm, 70 μm, 80 μm, 90 μm or 100 μm. However, the embodiments of the present disclosure are not limited thereto.

Here, the introduction is made by considering an example where the thickness of the first adhesive layer F1 is approximately 50 μm. In this case, the first adhesive layer F1 may not only meet the requirements of the adhesive strength of the first adhesive layer F1, but also be used to absorb the bending stress, thereby playing a role in protecting the transparent cover plate 10 and further preventing the cover plate assembly 101 from being too soft caused by the first adhesive layer F1.

It will be noted that due to certain uncontrollable errors (e.g., manufacturing process error, equipment accuracy, and measurement error), in a case where a floating range of error of the thickness of the first adhesive layer F1 is within −10%×50 μm to 10%×50 μm, it may be considered that the thickness of the first adhesive layer F1 is equal to 50 μm.

In addition, in some other examples, due to certain uncontrollable errors (e.g., manufacturing process errors, equipment accuracy, measurement errors), in a case where a floating range of error of the thickness of the first adhesive layer F1 is within −5%×50 μm to 5%×50 μm, it may be considered that the thickness of the first adhesive layer F1 is equal to 50 μm.

In some embodiments, since the first adhesive layer F1 fixes and connects the first protective layer 30 and the transparent cover plate 10, the first adhesive layer F1 is bonded to the transparent cover plate 10. Thus, the first adhesive layer F1 may be provided to be shrunk inwardly, so that an edge of an orthogonal projection of the first adhesive layer F1 on the transparent cover plate 10 is located inside the transparent cover plate 10. That is, the probability of the first adhesive layer F1 overflowing the transparent cover plate 10 may be reduced when the transparent cover plate 10 is bonded by the first adhesive layer F1, so as to improve the quality of the cover plate assembly 101.

In some examples, a distance between the edge of the orthogonal projection of the first adhesive layer F1 on the transparent cover plate 10 and an edge of the transparent cover plate 10 is greater than or equal to 0.2 mm.

In a case where the distance between the edge of the orthogonal projection of the first adhesive layer F1 on the transparent cover plate 10 and the edge of the transparent cover plate 10 is equal to or close to 0.2 mm, it is equivalent to reserving a space of 0.2 mm for the first adhesive layer F1. Due to the small reserved space, there is no problem of blank space and there is no problem of unstable bonding of part of the transparent cover plates 10. Moreover, the reserved space may also meet the flow requirements of the first adhesive layer F1 and thus prevent flue overflow of the cover plate assembly 101.

In some other examples, a distance between the edge of the orthogonal projection of the first adhesive layer F1 on the transparent cover plate 10 and an edge of the transparent cover plate 10 is less than or equal to 0.5 mm.

In a case where the distance between the edge of the orthogonal projection of the first adhesive layer F1 on the transparent cover plate 10 and the edge of the transparent cover plate 10 is equal to or close to 0.5 mm, it may reserve a space of 0.5 mm for the first adhesive layer F1, and the reserved space is sufficient, so as to well prevent flue overflow of the cover plate assembly 101. Moreover, there is no problem of blank space caused by excessively large reserved space.

In some other examples, a distance between the edge of the orthogonal projection of the first adhesive layer F1 on the transparent cover plate 10 and an edge of the transparent cover plate 10 is in a range of 0.2 mm to 0.5 mm, inclusive.

In a case where the distance between the edge of the orthogonal projection of the first adhesive layer F1 on the transparent cover plate 10 and the edge of the transparent cover plate 10 is in the range of 0.2 mm to 0.5 mm, inclusive, it may not only meet the flow requirements of the first adhesive layer, but also prevent the problem of blank space, which may be beneficial to improving the quality of the cover plate assembly 101.

In some other examples, a distance between the edge of the orthogonal projection of the first adhesive layer F1 on the transparent cover plate 10 and an edge of the transparent cover plate 10 is in a range of 0.2 mm to 0.3 mm, inclusive.

For example, in some other examples, the distance between the edge of the orthogonal projection of the first adhesive layer F1 on the transparent cover plate 10 and the edge of the transparent cover plate 10 is approximately 0.2 mm, 0.3 mm, 0.4 mm or 0.5 mm. However, the embodiments of the present disclosure are not limited thereto.

In some embodiments, since the first adhesive layer F1 fixes and connects the first protective layer 30 and the transparent cover plate 10, the first adhesive layer F1 is bonded to the first protective layer 30, and an edge of an orthogonal projection of the first adhesive layer F1 on the first protective layer 30 is located inside the first protective layer 30. That is, the probability of the first adhesive layer F1 overflowing the first protective layer 30 may be reduced when the first protective layer 30 is bonded by the first adhesive layer F1, so as to improve the quality of the cover plate assembly 101.

In some examples, a distance between the edge of the orthogonal projection of the first adhesive layer F1 on the first protective layer 30 and an edge of the first protective layer 30 is greater than or equal to 0.2 mm.

In a case where the distance between the edge of the orthogonal projection of the first adhesive layer F1 on the first protective layer 30 and the edge of the first protective layer 30 is equal to or close to 0.2 mm, it is equivalent to reserving a space of 0.2 mm for the first adhesive layer F1. Due to the small reserved space, there is no problem of blank space and there is no problem of unstable bonding of part of the first protective layer 30. Moreover, the reserved space may also meet the flow requirements of the first adhesive layer F1 and thus prevent flue overflow of the cover plate assembly 101.

In some other examples, a distance between the edge of the orthogonal projection of the first adhesive layer F1 on the first protective layer 30 and an edge of the first protective layer 30 is less than or equal to 0.5 mm.

In a case where the distance between the edge of the orthogonal projection of the first adhesive layer F1 on the first protective layer 30 and the edge of the first protective layer 30 is equal to or close to 0.5 mm, it may reserve a space of 0.5 mm for the first adhesive layer F1, and the reserved space is sufficient, so as to well prevent flue overflow of the cover plate assembly 101. Moreover, there is no problem of blank space caused by excessively large reserved space.

In some other examples, a distance between the edge of the orthogonal projection of the first adhesive layer F1 on the first protective layer 30 and an edge of the first protective layer 30 is in a range of 0.2 mm to 0.5 mm, inclusive.

In a case where the distance between the edge of the orthogonal projection of the first adhesive layer F1 on the first protective layer 30 and the edge of the first protective layer 30 is in the range of 0.2 mm to 0.5 mm, inclusive, it may not only meet the flow requirements of the first adhesive layer, but also prevent the problem of blank space, which may be beneficial to improving the quality of the cover plate assembly 101.

In some other examples, a distance between the edge of the orthogonal projection of the first adhesive layer F1 on the first protective layer 30 and an edge of the first protective layer 30 is in a range of 0.2 mm to 0.3 mm, inclusive.

For example, in some other examples, the distance between the edge of the orthogonal projection of the first adhesive layer F1 on the first protective layer 30 and the edge of the first protective layer 30 is approximately 0.2 mm, 0.3 mm, 0.4 mm or 0.5 mm. However, the embodiments of the present disclosure are not limited thereto.

In addition, the plurality of adhesive layers may further include other adhesive layers. The “other adhesive layers” may further include a second adhesive layer F2 and a third adhesive layer F3.

The second adhesive layer F2 is located between the transparent cover plate 10 and the first buffer layer 40, so that the second adhesive layer F2 is used to fix and bond the transparent cover plate 10 and the first buffer layer 40 to improve the stability of the cover plate assembly 101.

The third adhesive layer F3 is located between the first buffer layer 40 and the display substrate 102, so that the third adhesive layer F3 is used to fix and bond the first buffer layer 40 and the display substrate 102 to improve the stability of the cover plate assembly 101.

It will be noted that a material of the second adhesive layer F2 and a material of the third adhesive layer F3 may be the same as the material of the first adhesive layer F1, and details are not repeated here. In addition, a thickness of the second adhesive layer F2 and a thickness of the third adhesive layer F3 are similar to that of the first adhesive layer F1, an inward shrinkage degree of each adhesive layer (the adhesive layer shrunk inwardly relative to the film layers bonded thereto) is similar to that of the first adhesive layer F1, and details are not repeated here. However, the present disclosure is not limited thereto.

In some embodiments, in order to meet the requirements of the under-screen camera, a light-transmitting area Q is provided in the foldable display panel 100. The display substrate 102 in the foldable display panel 100 may include an opening Q1, and the opening Q1 of the display substrate 102 is provided corresponding to the light-transmitting area Q of the foldable display panel 100. That is, the opening Q1 of the display substrate 102 is located within the light-transmitting area Q of the foldable display panel 100. That is to say, space in the opening Q1 of the display substrate 102 in a thickness direction of the transparent cover plate 10 constitutes the light-transmitting area Q of the foldable display panel 100.

In addition, the light-transmitting hole H of the support plate 210 is also located within the light-transmitting area Q of the foldable display panel 100. With such a provision, the image light may be emitted into a photosensitive element such as an under-screen camera through the opening Q1 of the display substrate 102 and the light-transmitting hole H of the support plate 210, thereby realizing a full-screen design of the foldable display apparatus 200.

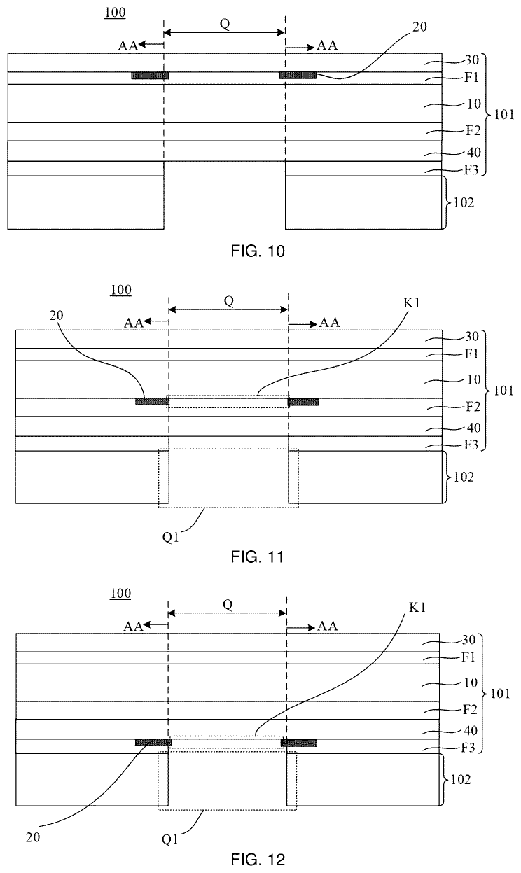

FIG. 10 is a structural diagram of a foldable display panel in accordance with some implementations.

In some implementations, referring to FIG. 10, in order to prevent light leakage at a position of the light-transmitting area Q, a first light-shielding layer 20 is required to be added to the foldable display panel 100, and the first light-shielding layer 20 is provided to surround at least part of the light-transmitting area Q, so that the first light-shielding layer 20 may be used to shield the light around the light-transmitting area Q, thereby improving the light leakage at the position of the light-transmitting area Q in the foldable display panel 100.

Generally, the first light-shielding layer 20 is disposed on a side of the transparent cover plate 10 away from the display substrate 102, so as to utilize the first light-shielding layer 20 to shield the film layers therebelow. That is, the first light-shielding layer 20 is disposed between the first protective layer 30 and the transparent cover plate 10. For example, the first light-shielding layer 20 is disposed between the first protective layer 30 and the first adhesive layer F1.

However, it has been discovered through research by inventors that due to a non-whole layer design of the first light-shielding layer 20 and the thickness of the first light-shielding layer 20 itself, the first adhesive layer F1 adjacent to the first light-shielding layer 20 is uneven. Specifically, a surface of a portion of the first adhesive layer F1 adjacent to the first light-shielding layer 20 may protrude from a surface of a portion of the first adhesive layer F1 not adjacent to the first light-shielding layer 20.

Based on this, the first adhesive layer F1 at the position of the light-transmitting area Q may be uneven, which will cause a large peak-to-valley value (PV) (greater than 0.8λ) at the position of the light-transmitting area Q, and cause to affect a propagation direction of light at the position of the light-transmitting area Q, so as to make the photographic imaging blurry, thereby reducing the imaging effect of the foldable display panel 100.

For example, the PV value at the position of the light-transmitting area Q is greater than or equal to 1.8λ.

In some other implementations, in order to reduce the PV value at the position of the light-transmitting area Q, a thinning process is performed on the first light-shielding layer 20. However, limited by the existing manufacturing process, the PV value at the position of the light-transmitting area Q may only be reduced to about 1.2λ, which is still greater than 0.8λ. Thus, the propagation direction of the light at the position of the light-transmitting area Q may still be affected, resulting in blurry photographic imaging. That is, the PV value at the position of the light-transmitting area Q cannot be reduced to below 0.8) by means of thinning the first light-shielding layer 20, which will still affect the imaging effect of the foldable display panel 100 and reduce the quality of the foldable display panel 100.

FIG. 11 is a structural diagram of another foldable display panel in accordance with some embodiments.

In order to solve the above problems, referring to FIG. 8, some embodiments of the present disclosure provide a foldable display panel 100, and the foldable display panel 100 includes a display area AA (active area, also referred to as active display area) and a light-transmitting area Q. The foldable display panel 100 further includes a cover plate assembly 101 and a display substrate 102, and the cover plate assembly 101 is located on a light-exit side of the display substrate 102. The cover plate assembly 101 includes a first protective layer 30, a transparent cover plate 10 and a first buffer layer 40 that are disposed sequentially.

In some examples, with continued reference to FIGS. 8 and 11, the first light-shielding layer 20 is provided to surround at least part of the light-transmitting area Q. The first light-shielding layer 20 surrounding at least part of the light-transmitting area Q includes the following several cases.

In the first case, the first light-shielding layer 20 may have a closed-loop structure, and the first light-shielding layer 20 is disposed around the light-transmitting area Q.

In the second case, the first light-shielding layer 20 may have a non-closed-loop structure, and the first light-shielding layer 20 is disposed around part of the light-transmitting area Q.

The embodiments of the present disclosure do not specifically limit the above two cases, and in both of the above two cases, the light leakage at the position of the light-transmitting area Q may be improved. The following description will be made by considering an example of the first case in which the first light-shielding layer 20 may have a closed-loop structure and the first light-shielding layer 20 is disposed around the light-transmitting area Q.

In some examples, the first light-shielding layer 20 includes a first opening K1. The orthogonal projection of the light-transmitting area Q on the transparent cover plate 10 at least partially overlaps with an orthogonal projection of the first opening K1 on the transparent cover plate 10. Thus, the first light-shielding layer 20 may well shield the light at the position of the light-transmitting area Q, thereby preventing light leakage at a position of an edge of the light-transmitting area Q of the foldable display panel 100.

The description of “the first light-shielding layer 20 including a first opening K1, and the orthogonal projection of the light-transmitting area Q on the transparent cover plate 10 at least partially overlapping with the orthogonal projection of the first opening K1 on the transparent cover plate 10” includes the following several cases.

In the first case, the first light-shielding layer 20 includes the first opening K1, and the orthogonal projection of the light-transmitting area Q on the transparent cover plate 10 partially overlaps with the orthogonal projection of the first opening K1 on the transparent cover plate 10.

With such a provision, the first light-shielding layer 20 may shield the light at the position of the light-transmitting area Q to a certain extent, thereby preventing light leakage at a position of an edge of the light-transmitting area Q of the foldable display panel 100.

In the second case, the first light-shielding layer 20 includes the first opening K1, and the orthogonal projection of the light-transmitting area Q on the transparent cover plate 10 covers the orthogonal projection of the first opening K1 on the transparent cover plate 10.

With such a provision, the first opening K1 of the first light-shielding layer 20 may enable the first light-shielding layer 20 to well shield the light at the position of the light-transmitting area Q, thereby preventing light leakage at a position of an edge of the light-transmitting area Q of the foldable display panel 100.

The relative position relationship between the orthogonal projection of the light-transmitting area Q on the transparent cover plate 10 and the orthogonal projection of the first opening K1 on the transparent cover plate 10 may include the following two cases.

In the first case, referring to FIG. 8, the orthogonal projection of the first opening K1 on the transparent cover plate 10 is located within the orthogonal projection of the light-transmitting area Q on the transparent cover plate 10.

Based on this, the first light-shielding layer 20 may extend into the light-transmitting area Q, and a portion of the first light-shielding layer 20 extending into the light-transmitting area Q may be used to well shield the light at an edge of the light-transmitting area Q to improve the light leakage in the light-transmitting area Q.

In some examples, for the first case, an edge of the orthogonal projection of the light-transmitting area Q on the transparent cover plate 10 and an edge of the orthogonal projection of the first opening K1 on the transparent cover plate 10 may be provided to have a first distance D1, and the first distance D1 takes a value less than or equal to 0.5 mm.

In a case where the first distance D1 is equal to or close to 0.5 mm, the first light-shielding layer 20 has a relatively large portion extending into the light-transmitting area Q, so that the first light-shielding layer 20 may well shield the light at the edge of the light-transmitting area Q to improve the light leakage in the light-transmitting area Q. In addition, the portion of the first light-shielding layer 20 extending into the light-transmitting area Q may be prevented from being too large, thereby preventing the light transmittance of the light-transmitting area Q from being affected.

In some other examples, the first distance D1 takes a value less than or equal to 0.2 mm.

In a case where the first distance D1 is equal to or close to 0.2 mm, not only may the first light-shielding layer 20 be used to shield the light at the edge of the light-transmitting area Q to prevent light leakage in the light-transmitting area Q, but also the first light-shielding layer 20 may be prevented from affecting the light transmittance of the light-transmitting area Q.

For example, the first distance D1 is approximately 0.1 mm, 0.2 mm, 0.3 mm, 0.4 mm or 0.5 mm. However, the embodiments of the present disclosure are not limited thereto.

In the second case, referring to FIG. 11, an edge of the orthogonal projection of the light-transmitting area Q on the transparent cover plate 10 substantially overlaps with an edge of the orthogonal projection of the first opening K1 on the transparent cover plate 10.

Based on this, an edge of the first light-shielding layer 20 may substantially coincide with an edge of the light-transmitting area Q. In this way, not only may the light at the edge of the light-transmitting area Q be shielded to improve the light leakage in the light-transmitting area Q, but also the first light-shielding layer 20 may be prevented from affecting the light transmittance of the light-transmitting area Q, so as to improve the quality of the foldable display panel 100.

It will be noted that the term “substantially overlap” in the second case may include absolute overlap and approximate overlap. That is, an absolute value of an interval between the edge of the orthogonal projection of the light-transmitting area Q on the transparent cover plate 10 and the edge of the orthogonal projection of the first opening K1 on the transparent cover plate 10 does not exceed an error threshold. It can also be considered that the edge of the orthogonal projection of the light-transmitting area Q on the transparent cover plate 10 and the edge of the orthogonal projection of the first opening K1 on the transparent cover plate 10 are relatively “overlapped”. A ratio of the error threshold to a length of the light-transmitting area Q may be in a range of 1% to 5%, inclusive.

Further, the first light-shielding layer 20 may be disposed on a side of the transparent cover plate 10 proximate to the display substrate 102. With such a provision, the first light-shielding layer 20 may be kept far away from a light-exit surface S1 of the foldable display panel 100 (as shown in FIG. 8). Furthermore, an adhesive layer (the second adhesive layer F2 or the third adhesive layer F3) having an uneven surface after the first light-shielding layer 20 is attached may be, relative to the first adhesive layer F1, further away from the light-exit surface of the foldable display panel 100.

Based on this, the first light-shielding layer 20 may be disposed to a side of the transparent cover plate 10 proximate to the display substrate 102 by moving the first light-shielding layer 20 to a side towards the display substrate 102. Thus, a distance between the first light-shielding layer 20 and the light-exit surface S1 of the foldable display panel 100 may be increased, and a distance between an adhesive layer bonded to the first light-shielding layer 20 and the light-exit surface S1 of the foldable display panel 100 may be increased. Therefore, the adhesive layer (the second adhesive layer

F2 or the third adhesive layer F3) bonded to the first light-shielding layer 20 is further away from the light-exit surface S1 of the foldable display panel 100 relative to the first adhesive layer F1, and an influence of unevenness of the second adhesive layer F2 or the third adhesive layer F3 on the PV value at the position of the light-transmitting area Q is smaller than an influence of unevenness of the first adhesive layer F1 on the PV value at the position of the light-transmitting area Q. As a result, the PV value at the position of the light-transmitting area Q may be reduced to below 0.8λ, and an influence on the propagation direction of the light at the position of the light-transmitting area Q may be reduced, so as to improve the clarity of photographic imaging and improve the quality of the foldable display panel 100.

FIG. 12 is a structural diagram of yet another foldable display panel in accordance with some embodiments.

It will be noted that the first light-shielding layer 20 is disposed on a side of the transparent cover plate 10 proximate to the display substrate 102, including the following two cases.

In the first case, the first light-shielding layer 20 is disposed between the transparent cover plate 10 and the first buffer layer 40.

For example, referring to FIG. 8, the first light-shielding layer 20 may be provided in contact with the transparent cover plate 10, and the first light-shielding layer 20 may be formed between the transparent cover plate 10 and the second adhesive layer F2.

For example, the first light-shielding layer 20 may not be in contact with the transparent cover plate 10, the first light-shielding layer 20 may be in contact with the first buffer layer 40, and the first light-shielding layer 20 may be formed between the first buffer layer 40 and the second adhesive layer F2.

With such a provision, the first light-shielding layer 20 is disposed on a side of the transparent cover plate 10 proximate to the display substrate 102, so that the first light-shielding layer 20 may be kept far away from the light-exit surface of the foldable display panel 100. Further, an adhesive layer (the second adhesive layer F2) having an uneven surface after the first light-shielding layer 20 is attached may be, relative to the first adhesive layer F1, further away from the light-exit surface of the foldable display panel 100.

Based on this, a distance between the first light-shielding layer 20 and the light-exit surface S1 of the foldable display panel 100 may be increased, and a distance between an adhesive layer bonded to the first light-shielding layer 20 and the light-exit surface S1 of the foldable display panel 100 may be increased. Therefore, the adhesive layer (the second adhesive layer F2) bonded to the first light-shielding layer 20 is further away from the light-exit surface S1 of the foldable display panel 100 relative to the first adhesive layer F1, and an influence of unevenness of the second adhesive layer F2 on the PV value at the position of the light-transmitting area Q is smaller than an influence of unevenness of the first adhesive layer F1 on the PV value at the position of the light-transmitting area Q. As a result, the PV value at the position of the light-transmitting area Q may be reduced to below 0.8λ, and an influence on the propagation direction of the light at the position of the light-transmitting area Q may be reduced, so as to improve the clarity of photographic imaging and improve the quality of the foldable display panel 100.

In the second case, the first light-shielding layer 20 is disposed between the first buffer layer 40 and the display substrate 102.

For example, referring to FIG. 12, the first light-shielding layer 20 is not in contact with the transparent cover plate 10, the first light-shielding layer 20 is in contact with the first buffer layer 40, and the first light-shielding layer 20 is formed between the first buffer layer 40 and the third adhesive layer F3.

For example, the first light-shielding layer 20 may not be in contact with the transparent cover plate 10, the first light-shielding layer 20 may not be in contact with the first buffer layer 40, the first light-shielding layer 20 may be in contact with the display substrate 102, and the first light-shielding layer 20 is formed between the display substrate 102 and the third adhesive layer F3.

With such a provision, the first light-shielding layer 20 is disposed on a side of the transparent cover plate 10 proximate to the display substrate 102, so that the first light-shielding layer 20 may be kept far away from the light-exit surface of the foldable display panel 100. Further, an adhesive layer (the third adhesive layer F3) having an uneven surface after the first light-shielding layer 20 is attached may be, relative to the first adhesive layer F1, further away from the light-exit surface of the foldable display panel 100.

Based on this, a distance between the first light-shielding layer 20 and the light-exit surface S1 of the foldable display panel 100 may be increased, and a distance between an adhesive layer bonded to the first light-shielding layer 20 and the light-exit surface S1 of the foldable display panel 100 may be increased. Therefore, the adhesive layer (the third adhesive layer F3) bonded to the first light-shielding layer 20 is further away from the light-exit surface S1 of the foldable display panel 100 relative to the first adhesive layer F1, and an influence of unevenness of the third adhesive layer F3 on the PV value at the position of the light-transmitting area Q is smaller than an influence of unevenness of the first adhesive layer F1 on the PV value at the position of the light-transmitting area Q. As a result, the PV value at the position of the light-transmitting area Q may be reduced to below 0.8λ, and an influence on the propagation direction of the light at the position of the light-transmitting area Q may be reduced, so as to improve the clarity of photographic imaging and improve the quality of the foldable display panel 100.

In addition, an influence of unevenness of the third adhesive layer F3 in the second provision manner on the PV value at the position of the light-transmitting area Q is smaller than an influence of unevenness of the second adhesive layer F2 in the first provision manner on the PV value at the position of the light-transmitting area Q.

Therefore, the first light-shielding layer 20 is disposed on the side of the first buffer layer 40 proximate to the display substrate 102, so that the PV value at the position of the light-transmitting area Q may be reduced to below 0.8λ, and an influence on the propagation direction of the light at the position of the light-transmitting area Q may be reduced, thereby improving the clarity of photographic imaging and improving the quality of the foldable display panel 100.

The above two manners are not limited in the present disclosure. Both of the above two manners may increase a distance between the first light-shielding layer 20 and the light-exit surface S1 of the foldable display panel 100, and increase a distance between an adhesive layer bonded to the first light-shielding layer 20 and the light-exit surface S1 of the foldable display panel 100. Therefore, the adhesive layer (the second adhesive layer F2 or the third adhesive layer F3) bonded to the first light-shielding layer 20 is further away from the light-exit surface S1 of the foldable display panel 100 relative to the first adhesive layer F1, and an influence of unevenness of the second adhesive layer F2 or the third adhesive layer F3 on the PV value at the position of the light-transmitting area Q is smaller than an influence of unevenness of the first adhesive layer F1 on the PV value at the position of the light-transmitting area Q. As a result, the PV value at the position of the light-transmitting area Q may be reduced to below 0.8λ, and an influence on the propagation direction of the light at the position of the light-transmitting area Q may be reduced, so as to improve the clarity of photographic imaging and improve the quality of the foldable display panel 100.

In some embodiments, referring to FIG. 8, the first light-shielding layer 20 may be an ink layer. A thickness of the first light-shielding layer 20 may be in a range of 2 μm to 5 μm, inclusive.

The thickness of the first light-shielding layer 20 in any of the above embodiments may be set in the above range. The first light-shielding layer 20 in the cover plate assembly 101 in any of the above embodiments moves downward (towards a side of the display substrate 102) to increase a distance between the first light-shielding layer 20 and the light-exit surface of the foldable display panel 100 and reduce an influence of an adhesive layer bonded to the first light-shielding layer 20 on the PV value at the position of the light-transmitting area Q, so that the PV value at the position of the light-transmitting area Q may be reduced to below 0.8λ. As a result, an influence on the propagation direction of the light at the position of the light-transmitting area Q may be reduced, so as to improve the clarity of photographic imaging and improve the quality of the foldable display panel 100.

Based on this, in the foldable display panel 100 provided in the embodiments of the present disclosure, the thickness of the first light-shielding layer 20 in the cover plate assembly 101 may be set within the range of 2 μm to 5 μm, inclusive, and there is no need to perform a thinning process on the first light-shielding layer 20, thereby meeting the requirements of the existing manufacturing process of the first light-shielding layer.

In a case where the thickness of the first light-shielding layer 20 is equal to or close to 2 μm, the first light-shielding layer 20 has a relatively small thickness, which may not only meet the light-shielding degree requirements of the first light-shielding layer 20, but also meet the requirements of the existing manufacturing process. In addition, an influence of the first light-shielding layer 20 on the PV value at the position of the light-transmitting area Q may also be reduced, thereby improving the clarity of photographic imaging of the foldable display panel 100.

In a case where the thickness of the first light-shielding layer 20 is equal to or close to 5 μm, the first light-shielding layer 20 has a relatively large thickness, so that the first light-shielding layer 20 may have a rather good light-shielding effect to prevent light leakage at the position of the light-transmitting area Q. Moreover, the thickness of the first light-shielding layer 20 will not be too large, so as to reduce the influence on the PV value at the position of the light-transmitting area Q to a certain extent, thereby improving the clarity of photographic imaging of the foldable display panel 100.

For example, the thickness of the first light-shielding layer 20 is approximately 2 μm, 3 μm, 4 μm or 5 μm. However, the embodiments of the present disclosure are not limited thereto.

It will be noted that the first light-shielding layer 20 is formed between the transparent cover plate 10 and the display substrate 102, which may also include two structures.

The first structure is an improvement for the structure of the cover plate assembly 101 in the foldable display panel 100. That is, the first light-shielding layer 20 is disposed in the cover plate assembly 101, and the first light-shielding layer 20 belongs to the structure inside the cover plate assembly 101.

The second structure is an improvement for the structure of the foldable display panel 100. That is, the first light-shielding layer 20 is disposed between the cover plate assembly 101 and the display substrate 102.

The first case in which the improvement for the structure of the cover plate assembly 101 in the foldable display panel 100 is introduced partially in FIGS. 8 and 12. The structure of the cover plate assembly 101 will be further described below in conjunction with some related drawings. In addition, the second case in which the improvement for the structure of the foldable display panel 100 will be introduced below in conjunction with some other related drawings.

To sum up, in the embodiments provided by the present disclosure, the first light-shielding layer 20 is provided to include the first opening K1, and the orthogonal projection of the light-transmitting area Q on the transparent cover plate 10 covers the orthogonal projection of the first opening K1 on the transparent cover plate 10. In this way, the first light-shielding layer 20 may be used to improve the light leakage in the light-transmitting area Q of the foldable display panel 100. Moreover, the first light-shielding layer 20 may be disposed to a side of the transparent cover plate 10 proximate to the display substrate 102 by moving the first light-shielding layer 20 to a side towards the display substrate 102. Thus, a distance between the first light-shielding layer 20 and the light-exit surface S1 of the foldable display panel 100 may be increased, and a distance between an adhesive layer bonded to the first light-shielding layer 20 and the light-exit surface S1 of the foldable display panel 100 may be increased. Therefore, the adhesive layer (the second adhesive layer F2) bonded to the first light-shielding layer 20 is further away from the light-exit surface S1 of the foldable display panel 100 relative to the first adhesive layer F1, and an influence of unevenness of the second adhesive layer F2 on the PV value at the position of the light-transmitting area Q is smaller than an influence of unevenness of the first adhesive layer F1 on the PV value at the position of the light-transmitting area Q. As a result, the PV value at the position of the light-transmitting area Q may be reduced to below 0.8), and an influence on the propagation direction of the light at the position of the light-transmitting area Q may be reduced, so as to improve the clarity of photographic imaging and improve the quality of the foldable display panel 100.

In some embodiments, referring to FIG. 8, the third adhesive layer F3 may include a third opening K3, and an edge of an orthogonal projection of the third opening K3 on the transparent cover plate 10 substantially overlaps with an edge of the orthogonal projection of the light-transmitting area Q on the transparent cover plate.

Such a provision is equivalent to removing a portion of the third adhesive layer F3 at a position of the light-transmitting area Q, so as to prevent the portion of the third adhesive layer F3 at the position of the light-transmitting area Q from affecting the bending of the foldable display panel 100, and also prevent a surface of the third adhesive layer F3 away from the first buffer layer 40 from being contaminated, thereby improving the yield rate of the foldable display panel 100.

It will be noted that the term “substantially overlap” may include absolute overlap and approximate overlap. That is, an absolute value of an interval between the edge of the orthogonal projection of the light-transmitting area Q on the transparent cover plate 10 and the edge of the orthogonal projection of the third opening K3 on the transparent cover plate 10 does not exceed an error threshold. It can also be considered that the edge of the orthogonal projection of the light-transmitting area Q on the transparent cover plate 10 and the edge of the orthogonal projection of the third opening K3 on the transparent cover plate 10 are relatively “overlapped”. A ratio of the error threshold to a length of the light-transmitting area Q may be in a range of 1% to 5%, inclusive.

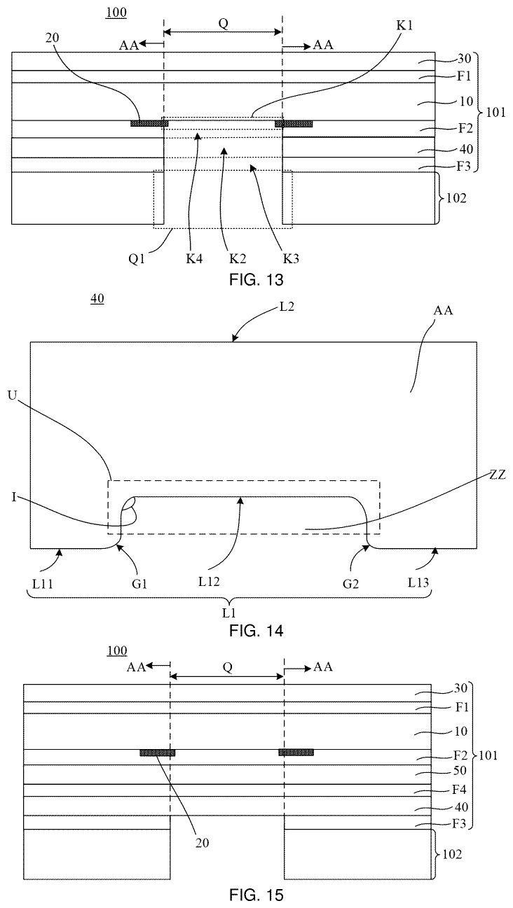

FIG. 13 is a structural diagram of yet another foldable display panel in accordance with some embodiments.

In some other embodiments, referring to FIG. 13, the first buffer layer 40 may further include a second opening K2, and an edge of an orthogonal projection of the second opening K2 on the transparent cover plate 10 substantially overlaps with an edge of an orthogonal projection of the light-transmitting area Q on the transparent cover plate.

Such a provision is equivalent to removing a portion of the first buffer layer 40 at the position of the light-transmitting area Q, so as to prevent the portion of the first buffer layer 40 at the position of the light-transmitting area Q from affecting the bending of the foldable display panel 100, thereby improving the bendability of the foldable display panel 100.

It will be noted that the term “substantially overlap” may include absolute overlap and approximate overlap. That is, an absolute value of an interval between the edge of the orthogonal projection of the light-transmitting area Q on the transparent cover plate 10 and the edge of the orthogonal projection of the second opening K2 on the transparent cover plate 10 does not exceed an error threshold. It can also be considered that the edge of the orthogonal projection of the light-transmitting area Q on the transparent cover plate 10 and the edge of the orthogonal projection of the second opening K2 on the transparent cover plate 10 are relatively “overlapped”. A ratio of the error threshold to a length of the light-transmitting area Q may be in a range of 1% to 5%, inclusive.

In some other embodiments, referring to FIG. 13, on a basis that the first buffer layer 40 may further include the second opening K2, the second adhesive layer F2 between the first buffer layer 40 and the transparent cover plate 10 may include a fourth opening K4. An edge of an orthogonal projection of the fourth opening K4 on the transparent cover plate 10 substantially overlaps with an edge of the orthogonal projection of the light-transmitting area Q on the transparent cover plate.

Such a provision is equivalent to removing a portion of the second adhesive layer F2 at the position of the light-transmitting area Q, so as to prevent the portion of the second adhesive layer F2 at the position of the light-transmitting area Q from affecting the bending of the foldable display panel 100, and also prevent a surface of the second adhesive layer F2 proximate to the first buffer layer 40 from being contaminated, thereby improving the yield rate of the foldable display panel 100.

It will be noted that the term “substantially overlap” may include absolute overlap and approximate overlap. That is, an absolute value of an interval between the edge of the orthogonal projection of the light-transmitting area Q on the transparent cover plate 10 and the edge of the orthogonal projection of the fourth opening K4 on the transparent cover plate 10 does not exceed an error threshold. It can also be considered that the edge of the orthogonal projection of the light-transmitting area Q on the transparent cover plate 10 and the edge of the orthogonal projection of the fourth opening K4 on the transparent cover plate 10 are relatively “overlapped”. A ratio of the error threshold to a length of the light-transmitting area Q may be in a range of 1% to 5%, inclusive.

FIG. 14 is a plan view of the first buffer layer in FIG. 6.

In some embodiments, referring to FIGS. 6 and 14, the foldable display panel 100 further includes a bending area ZZ located on a side of the display area AA.

The first buffer layer 40 includes a first side edge L1 and a second side edge L2 that are disposed opposite to each other, and the first side edge L1 is located on a side of the second side edge L2 proximate to the bending area ZZ. The first side edge L1 includes a first line segment L11, a first arc transition segment G1, a second line segment L12, a second arc transition segment G2 and a third line segment L13 that are connected in sequence. The second line segment L12 protrudes toward the second side edge L2 relative to the first line segment L11 and the third line segment L13 to define a groove structure U, and the groove structure U is located in the bending area.

With such a provision, the first buffer layer 40 may form the groove structure U by using the second line segment L12 to avoid the bending area ZZ in the foldable display panel 100, so as to prevent the provision of the structure at a position of the bending area ZZ in the foldable display panel 100 from being affected.

Moreover, the first arc transition segment G1 and the second arc transition segment G2 are added in the first side edge L1 of the first buffer layer 40. The first line segment L11 and the second line segment L12 are connected by the first arc transition segment G1, and the third line segment L13 and the second line segment L12 are connected by the second arc transition segment G2.

Based on this, the first arc transition segment G1 and the second arc transition segment G2 in the first side edge L1 may be used to release the bending stress, so as to prevent the first buffer layer 40 from being torn at a position of the bending area ZZ, thereby improving the quality of the foldable display panel 100.

In some examples, bottom corners I of the groove structure U defined by the second line segment L12 protruding toward the second side edge L2 are round corners.

With such a provision, the first buffer layer 40 utilizes a structure of the first arc transition segment G1, the second line segment L12 and the second arc transition segment G2 being sequentially connected to enable the first arc transition segment G1 and a side wall (the side wall connected to the first arc transition segment G1) of the groove structure U to form an “S”-shaped structure, and enable the second arc transition segment G2 and the other side wall (the side wall connected to the second arc transition segment G2) of the groove structure U to form another “S”-shaped structure.

Based on this, the first arc transition segment G1 and the second arc transition segment G2 in the first side edge L1 and the two bottom corners I (round corners) of the groove structure U may be used to release the bending stress, so as to prevent the first buffer layer 40 from being torn at a position of the bending area ZZ, thereby improving the quality of the foldable display panel 100.

In some examples, in a case where the bottom corner I of the groove structure U is a round corner, a radius thereof is in a range of 0.2 mm to 1 mm, inclusive.

In a case where the radius of the bottom corner of the groove structure U is in the range of 0.2 mm to 1 mm, inclusive, the bottom corner of the groove structure U may be arc-shaped, which may be used to release the bending stress, so as to prevent the first buffer layer 40 from being torn at a position of the bending area ZZ, thereby improving the quality of the foldable display panel 100.

For example, the radius of the bottom corner of the groove structure U is approximately 0.2 mm, 0.3 mm, 0.4 mm, 0.5 mm, 0.6 mm, 0.7 mm, 0.8 mm, 0.9 mm or 1 mm.

It will be noted that the introduction is made by considering an example where the radius of the bottom corner of the groove structure U is approximately 0.5 mm. Due to certain uncontrollable errors (e.g., manufacturing process error, equipment accuracy, and measurement error), in a case where a floating range of error of the radius of the bottom corner of the groove structure U is within −10%×0.5 mm to 10%×0.5 mm, it may be considered that the radius of the bottom corner of the groove structure U is equal to 0.5 mm.

In addition, in some other examples, due to certain uncontrollable errors (e.g., manufacturing process error, equipment accuracy, and measurement error), in a case where a floating range of error of the radius of the bottom corner of the groove structure U is within −5%×0.5 mm to 5%×0.5 mm, it may be considered that the radius of the bottom corner of the groove structure U is equal to 0.5 mm.

FIG. 15 is a structural diagram of film layers of a foldable display panel in accordance with some embodiments.

Considering the subsequent requirements for improvement of bead falling testing specifications, the bead falling specification need to be met to be more than 2 cm (the determination standard is normal display of the screen).

Based on this, in some embodiments, referring to FIG. 15, the foldable display panel 100 further includes a second buffer layer 50. The second buffer layer 50 is located on a side of the first buffer layer 40 proximate to the transparent cover plate 10. The second buffer layer 50 is disposed between the first buffer layer 40 and the transparent cover plate 10. A material of the second buffer layer 50 may be different from a material of the first buffer layer 40, and an elastic modulus of the second buffer layer 50 is less than or equal to an elastic modulus of the first buffer layer 40.

With the above structure, the foldable display panel 100 may increase hardness and rebound force of the foldable display panel 100 by adding the second buffer layer 50. When a bead falling test is carried out, the second buffer layer 50 is generally impacted first. After being impacted, the second buffer layer 50 deforms to absorb stress, so as to protect the first buffer layer 40 and reduce deformation of the first buffer layer 40. In this way, the first buffer layer 40 transmits slight deformation to the display substrate 102, so as to reduce the deformation of the display substrate 102, that is, the strength of the cover plate assembly 101 may be increased, and the possibility of damage to the cover plate assembly 101 may be reduced. Moreover, the second buffer layer 50 has relatively great elasticity, and the second buffer layer 50 may be used to further disperse the impact stress, so as to improve damage and corner breakage of the transparent cover plate 10 during the bead falling test, thereby improving the quality of the foldable display panel 100.

In some examples, referring to FIG. 15, the elastic modulus of the second buffer layer 50 may be in a range of 5 MPa to 100 MPa, inclusive.

In a case where the elastic modulus of the second buffer layer 50 is equal to or close to 5 MPa, the second buffer layer 50 has a relatively small elastic modulus, which is beneficial to improving the bendability of the foldable display panel 100. In addition, the second buffer layer 50 may meet the requirements of impact resistance and resilience, so as to play a role in protecting the transparent cover plate 10, thereby preventing the transparent cover plate 10 from being broken when the foldable display panel 100 is impacted by external force.

In a case where the elastic modulus of the second buffer layer 50 is equal to or close to 100 MPa, the second buffer layer 50 has a relatively large elastic modulus, so that the second buffer layer has good impact resistance and resilience, thereby preventing the transparent cover plate 10 from being broken. In addition, the second buffer layer 50 may meet the bendability requirements of the foldable display panel 100.

In some examples, the elastic modulus of the second buffer layer 50 may be in a range of 20 MPa to 80 MPa, inclusive.

In a case where the elastic modulus of the second buffer layer 50 is in the range of 20 MPa to 80 MPa, inclusive, the second buffer layer 50 may not only meet the requirements of bendability of the foldable display panel 100, but also meet the requirements of impact resistance and resilience, so as to protect the transparent cover plate 10.

For example, the elastic modulus of the second buffer layer 50 is approximately 5 MPa, 10 MPa, 20 MPa, 30 MPa, 40 MPa, 50 MPa, 60 MPa, 70 MPa, 80 MPa, 90 MPa or 100 MPa.

The introduction is made by considering an example where the elastic modulus of the second buffer layer 50 is approximately 50 MPa, the second buffer layer 50 may have rather good impact resistance and resilience to prevent the transparent cover plate 10 from being broken, and may also meet the bendability requirements of the foldable display panel 100.

It will be noted that due to certain uncontrollable errors (e.g., manufacturing process error, equipment accuracy, and measurement error), in a case where a floating range of error of the elastic modulus of the second buffer layer 50 is within −10%×50 MPa to 10%×50 MPa, it may be considered that the elastic modulus of the second buffer layer 50 is equal to 50 MPa.

In addition, in some other examples, due to certain uncontrollable errors (e.g., manufacturing process error, equipment accuracy, and measurement error), in a case where a floating range of error of the elastic modulus of the second buffer layer 50 is within −5%×50 MPa to 5%×50 MPa, it may be considered that the elastic modulus of the second buffer layer 50 is equal to 50 MPa.

In some examples, referring to FIG. 15, a material of the second buffer layer 50 may be thermoplastic polyurethane (TPU).

The thermoplastic polyurethane (TPU) is formed on a side of the transparent cover plate 10 proximate to the display substrate 102. The thermoplastic polyurethane (TPU) has relatively good elasticity and the thermoplastic polyurethane (TPU) may be used to further disperse the impact stress, so as to play a role in protecting the transparent cover plate 10, thereby preventing the transparent cover plate 10 from being broken when the foldable display panel 100 is impacted by external force.

In some examples, a thickness of the second buffer layer 50 may be in a range of 50 μm to 200 μm, inclusive.

In a case where the thickness of the second buffer layer 50 is equal to or close to 50 μm, the second buffer layer 50 may have a small thickness. The second buffer layer 50 may provide rather good impact resistance and resilience for the cover plate assembly 101, so as to use the second buffer layer 50 to further disperse the impact stress, thereby playing a role in protecting the transparent cover plate 10 and preventing the transparent cover plate 10 from being broken when the foldable display panel 100 is impacted by external force. Moreover, it may also be beneficial to lightness and thinness of the foldable display panel 100.

In a case where the thickness of the second buffer layer 50 is equal to or close to 200 μm, the second buffer layer 50 may have a large thickness. The second buffer layer 50 may make the cover plate assembly 101 have good flexibility, so as to meet the bendability requirements of the foldable display panel 100. In addition, the second buffer layer 50 may also make the cover plate assembly 101 have good impact resistance and resilience, so as to use the second buffer layer 50 to further disperse the impact stress, thereby playing a role in protecting the transparent cover plate 10 and preventing the transparent cover plate 10 from being broken when the foldable display panel 100 is impacted by external force.

In some other examples, a thickness of the second buffer layer 50 may be in a range of 80 μm to 120 μm, inclusive.

In a case where the thickness of the second buffer layer 50 is equal to or close to 80 μm, the second buffer layer 50 may provide rather good impact resistance and resilience for the cover plate assembly 101, so as to use the second buffer layer 50 to further disperse the impact stress, thereby playing a role in protecting the transparent cover plate 10 and preventing the transparent cover plate 10 from being broken when the foldable display panel 100 is impacted by external force.

In a case where the thickness of the second buffer layer 50 is equal to or close to 120 μm, the second buffer layer 50 may make the cover plate assembly 101 have good flexibility, so as to meet the bendability requirements of the foldable display panel 100. In addition, the second buffer layer 50 may also make the cover plate assembly 101 have good impact resistance and resilience, thereby preventing the transparent cover plate 10 from being broken.

For example, the thickness of the second buffer layer 50 is approximately 80 μm, 90 μm, 100 μm, 110 μm or 120 μm.

The introduction is made by considering an example where the thickness of the second buffer layer 50 is approximately 100 μm. In this case, the second buffer layer 50 may not only make the cover plate assembly 101 have good flexibility, so as to meet the bendability requirements of the foldable display panel 100, but also make the cover plate assembly 101 have relatively good impact resistance and resilience, so that the second buffer layer 50 may be used to further disperse the impact stress, thereby playing a role in protecting the transparent cover plate 10 and preventing the transparent cover plate 10 from being broken when the foldable display panel 100 is impacted by external force.

It will be noted that the introduction is made by considering an example where the thickness of the second buffer layer 50 is approximately 100 μm. Due to certain uncontrollable errors (e.g., manufacturing process error, equipment accuracy, and measurement error), in a case where a floating range of error of the thickness of the second buffer layer 50 is within −10%×100 μm to 10%×100 μm, it may be considered that the thickness of the second buffer layer 50 is equal to 100 μm.

In addition, in some other examples, due to certain uncontrollable errors (e.g., manufacturing process error, equipment accuracy, and measurement error), in a case where a floating range of error of the thickness of the second buffer layer 50 is within −5%×100 μm to 5%×100 μm, it may be considered that the thickness of the second buffer layer 50 is equal to 100 μm.

In some embodiments, with reference to FIG. 17, in a case where the second buffer layer 50 is added into the cover plate assembly 101, the thickness of the transparent cover plate 10 may be caused to increase to a certain extent, and the impact resistance and the resilience of the cover plate assembly 101 may also be improved.

Based on this, a thinning process may be performed on the transparent cover plate 10. That is, in this case, the thickness of the transparent cover plate 10 may be set to about 40 μm, which is about 10 μm thinner than the transparent cover plate 10 with a thickness of 50 μm.

With such a setting, the thinning process performed on the transparent cover plate 10 may be beneficial to reducing the thickness of the cover plate assembly 101 and reducing the hardness of the cover plate assembly 101, so that the cover plate assembly 101 may rather well meet the bendability requirements of the foldable display panel 100.

For example, in a case where the second buffer layer 50 is added into the cover plate assembly 101 and the thinning process is performed on the transparent cover plate 10, the thickness of the cover plate assembly 101 may still be caused to increase to a certain extent. For example, the thickness of the cover plate assembly 101 may increase by more than 100 μm compared with the thickness of the cover plate assembly 101 shown in FIG. 9. However, such a provision may also increase the impact resistance and the resilience of the cover plate assembly 101. For example, the impact resistance and the resilience of the cover plate assembly 101 may increase by 2.14% compared with the impact resistance and the resilience of the cover plate assembly 101 shown in FIG. 9, so as to meet the requirements of the hinge design when the foldable display panel 100 is bent subsequently.

In some embodiments, with continued reference to FIG. 17, the cover plate assembly 101 may further include a fourth adhesive layer F4, and the fourth adhesive layer F4 is located between the second buffer layer 50 and the first buffer layer 40. The fourth adhesive layer F4 may fix and connect the second buffer layer 50 and the first buffer layer 40 to improve the stability of the cover plate assembly 101, thereby improving the yield rate of the foldable display panel 100.

In some examples, a material of the fourth adhesive layer F4 may be an optically clear adhesive (OCA). Since the optically clear adhesive (OCA) has a certain stickiness, the second buffer layer 50 and the first buffer layer 40 may be fixed and connected to improve the stability of the cover plate assembly 101. In addition, since the optically clear adhesive (OCA) has a relatively soft texture and a certain elasticity, the optically clear adhesive (OCA) may effectively absorb part of the bending stress and may also play a role in protecting the transparent cover plate 10 to a certain extent, thereby preventing the transparent cover plate 10 from being broken when the foldable display panel 100 is impacted by external force.

In addition, the thickness and the inward shrinkage degree of the fourth adhesive layer F4 may be similar to those of the first adhesive layer F1. Further, reference may be made to the description of the first adhesive layer F1 in the above embodiments, and details are not repeated here.

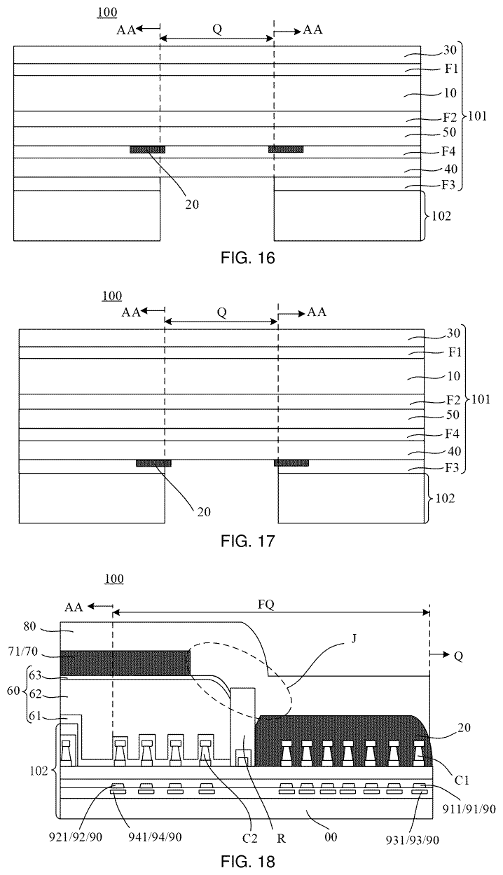

FIG. 16 is a structural diagram of film layers of another foldable display panel in accordance with some embodiments. FIG. 17 is a structural diagram of film layers of another foldable display panel in accordance with some embodiments.

In some embodiments, in combination with FIGS. 15 to 17, in a case where the second buffer layer 50 is added into the cover plate assembly 101, the location at which the first light-shielding layer 20 is located may include the following three cases.

In the first case, referring to FIG. 15, the first light-shielding layer 20 is disposed between the transparent cover plate 10 and the second buffer layer 50. In this case, similar to the structure shown in FIG. 8, it is equivalent to that the first light-shielding layer 20 is disposed between the transparent cover plate 10 and the second adhesive layer F2.

With such a provision, the first light-shielding layer 20 is disposed on a side of the transparent cover plate 10 proximate to the display substrate 102, so that the first light-shielding layer 20 may be kept far away from the light-exit surface of the foldable display panel 100. Further, an adhesive layer (the second adhesive layer F2) having an uneven surface after the first light-shielding layer 20 is attached may be, relative to the first adhesive layer F1, further away from the light-exit surface of the foldable display panel 100.

Based on this, a distance between the first light-shielding layer 20 and the light-exit surface S1 of the foldable display panel 100 may be increased, and a distance between an adhesive layer bonded to the first light-shielding layer 20 and the light-exit surface S1 of the foldable display panel 100 may be increased. Therefore, the adhesive layer (the second adhesive layer F2) bonded to the first light-shielding layer 20 is further away from the light-exit surface S1 of the foldable display panel 100 relative to the first adhesive layer F1, and an influence of unevenness of the second adhesive layer F2 on the PV value at the position of the light-transmitting area Q is smaller than an influence of unevenness of the first adhesive layer F1 on the PV value at the position of the light-transmitting area Q. As a result, the PV value at the position of the light-transmitting area Q may be reduced to below 0.8λ, and an influence on the propagation direction of the light at the position of the light-transmitting area Q may be reduced, so as to improve the clarity of photographic imaging and improve the quality of the foldable display panel 100.

In the second case, referring to FIG. 16, the first light-shielding layer 20 is disposed between the second buffer layer 50 and the first buffer layer 40.

With such a provision, the first light-shielding layer 20 is disposed on a side of the transparent cover plate 10 proximate to the display substrate 102, so that a distance between the first light-shielding layer 20 and the light-exit surface of the foldable display panel 100 may further be increased. Further, an adhesive layer (the fourth adhesive layer F4) having an uneven surface after the first light-shielding layer 20 is attached may be, relative to the first adhesive layer F1, further away from the light-exit surface of the foldable display panel 100.

Based on this, the first light-shielding layer 20 further moves downward (towards a side of the display substrate 102) to a side of the second buffer layer 50 proximate to the display substrate 102, so as to increase a distance between the first light-shielding layer 20 and the light-exit surface of the foldable display panel 100, and increase a distance between an adhesive layer bonded to the first light-shielding layer 20 and the light-exit surface S1 of the foldable display panel 100. Therefore, the adhesive layer (the fourth adhesive layer F4) bonded to the first light-shielding layer 20 is further away from the light-exit surface S1 of the foldable display panel 100 relative to the first adhesive layer F1, and an influence of unevenness of the fourth adhesive layer F4 on the PV value at the position of the light-transmitting area Q is smaller than an influence of unevenness of the first adhesive layer F1 on the PV value at the position of the light-transmitting area Q.

Moreover, the adhesive layer (the fourth adhesive layer F4) bonded to the first light-shielding layer 20 is further away from the light-exit surface S1 of the foldable display panel 100 relative to the second adhesive layer F2, and an influence of unevenness of the fourth adhesive layer F4 on the PV value at the position of the light-transmitting area Q is smaller than an influence of unevenness of the second adhesive layer F2 on the PV value at the position of the light-transmitting area Q.

Therefore, the first light-shielding layer 20 is disposed on the side of the second buffer layer 50 proximate to the display substrate 102, so that the PV value at the position of the light-transmitting area Q may be reduced to below 0.8λ, and an influence on the propagation direction of the light at the position of the light-transmitting area Q may be reduced, thereby improving the clarity of photographic imaging and improving the quality of the foldable display panel 100.

In the third case, referring to FIG. 17, the first light-shielding layer 20 is located on a side of the first buffer layer 40 proximate to the display substrate 102. That is, the first light-shielding layer 20 is disposed between the first buffer layer 40 and the display substrate 102.

With such a provision, the first light-shielding layer 20 is disposed on a side of the transparent cover plate 10 proximate to the display substrate 102, or the first light-shielding layer 20 is disposed on a side of the second buffer layer 50 proximate to the display substrate 102, so that a distance between the first light-shielding layer 20 and the light-exit surface of the foldable display panel 100 may further be increased. Further, an adhesive layer (the third adhesive layer F3) having an uneven surface after the first light-shielding layer 20 is attached may be, relative to the first adhesive layer F1, further away from the light-exit surface of the foldable display panel 100.

Based on this, the first light-shielding layer 20 further moves downward (towards a side of the display substrate 102) to a side of the first buffer layer 40 proximate to the display substrate 102, so as to increase a distance between the first light-shielding layer 20 and the light-exit surface of the foldable display panel 100, and increase a distance between an adhesive layer bonded to the first light-shielding layer 20 and the light-exit surface S1 of the foldable display panel 100. Therefore, the adhesive layer (the third adhesive layer F3) bonded to the first light-shielding layer 20 is further away from the light-exit surface S1 of the foldable display panel 100 relative to the first adhesive layer

F1, and an influence of unevenness of the third adhesive layer F3 on the PV value at the position of the light-transmitting area Q is smaller than an influence of unevenness of the first adhesive layer F1 on the PV value at the position of the light-transmitting area Q.

Moreover, the adhesive layer (the third adhesive layer F3) bonded to the first light-shielding layer 20 is further away from the light-exit surface S1 of the foldable display panel 100 relative to the second adhesive layer F2 and the fourth adhesive layer F4, and an influence of unevenness of the third adhesive layer F3 on the PV value at the position of the light-transmitting area Q is smaller than an influence of unevenness of the second adhesive layer F2 on the PV value at the position of the light-transmitting area Q and an influence of unevenness of the fourth adhesive layer F4 on the PV value at the position of the light-transmitting area Q.

Therefore, the first light-shielding layer 20 is disposed on the side of the first buffer layer 40 proximate to the display substrate 102, so that the PV value at the position of the light-transmitting area Q may be reduced to below 0.8λ, and an influence on the propagation direction of the light at the position of the light-transmitting area Q may be reduced, thereby improving the clarity of photographic imaging and improving the quality of the foldable display panel 100.

In some embodiments, in a case where the foldable display panel 100 includes the second buffer layer 50, the second buffer layer 50 also needs to avoid the bending area. That is, the second buffer layer 50 may have substantially the same structure as the first buffer layer 40. That is, a corresponding “S”-shaped design is also made at a position of the second buffer layer 50 corresponding to the first side edge L1 of the first buffer layer 40 to release the bending stress and prevent the second buffer layer 50 from being torn.

In some other examples, the cover plate assembly 101 may further include an auxiliary transparent cover plate, and the auxiliary transparent cover plate may be located between the transparent cover plate 10 and the first buffer layer 40. In a case where the cover plate assembly 101 includes the second buffer layer 50, the auxiliary transparent cover plate may be located between the transparent cover plate 10 and the second buffer layer 50.

The auxiliary transparent cover plate is added into the cover plate assembly 101, and the auxiliary transparent cover plate may be used to increase the hardness of the cover plate assembly 101, so that the transparent cover plate 10 may not only achieve an effect of protecting the display substrate 102 for a long time, but also play a role in supporting and protecting the transparent cover plate 10 by using the auxiliary transparent cover plate.

In some examples, a material of the auxiliary transparent cover plate may be ultra-thin glass (UTG). The ultra-thin glass may not only further increase the hardness of the cover plate assembly 101, but also meet the bendability requirements of the foldable display panel 100. Moreover, the ultra-thin glass may also have relatively high clarity to improve the quality of photographic imaging of the foldable display panel 100.

In addition, for parameters such as the thickness and the elastic modulus of the auxiliary transparent cover plate, reference may be made to the description of the transparent cover plate 10 in the above embodiments, and details are not repeated here.

The above text mainly describes that the position of the first light-shielding layer 20 in the cover plate assembly 101 is changed to improve the clarity of photographic imaging of the foldable display panel 100 and improve the quality of the foldable display panel 100. The following text will introduce another solution for improving the clarity of photographic imaging of the foldable display panel 100 and improving the quality of the foldable display panel 100 in conjunction with the relevant drawings.

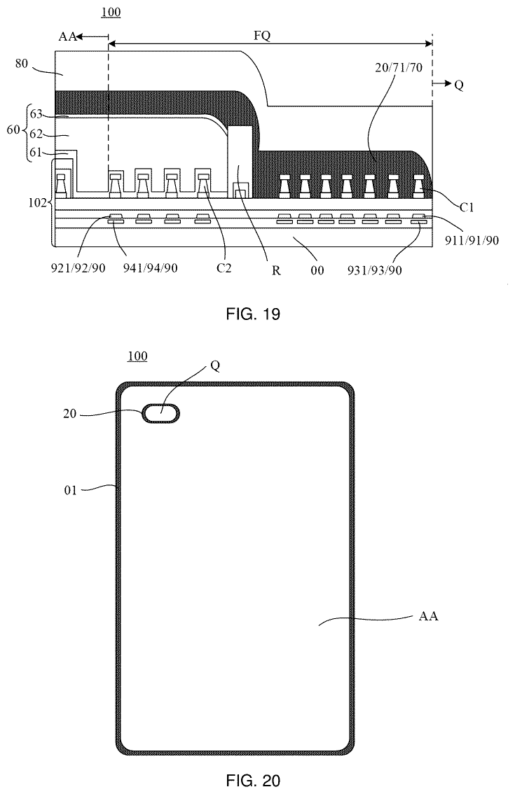

FIG. 18 is a structural diagram of another foldable display panel in accordance with some embodiments. FIG. 19 is a structural diagram of another foldable display panel in accordance with some embodiments.

In some embodiments, in combination with FIGS. 18 and 19, the foldable display panel 100 may further include an encapsulation layer 60, and the encapsulation layer 60 is located on a side of the display substrate 102 proximate to the cover plate assembly 101. The encapsulation layer 60 may be used to isolate moisture, so as to prevent failure of the devices (the light-emitting devices O) in the display substrate 102 caused by the moisture entering the display substrate 102, thereby increasing the life of the foldable display panel 100.

For example, the encapsulation layer 60 includes a first inorganic encapsulation layer 61, an organic encapsulation layer 62 and a second inorganic encapsulation layer 63. The organic encapsulation layer 62 is located between the first inorganic encapsulation layer 61 and the second inorganic encapsulation layer 63, and the first inorganic encapsulation layer 61 is closer to the display substrate 102 than the organic encapsulation layer 62.

In addition, the encapsulation layer 60 may further include more inorganic encapsulation layers and more organic encapsulation layers, but generally speaking, it is necessary to ensure that the top layer (a layer in the encapsulation layer 60 farthest away from the display substrate 102) in the encapsulation layer 60 is an inorganic encapsulation layer, so as to effectively isolate moisture and oxygen.

In some examples, a material of the first inorganic encapsulation layer 61 may be SiON (silicon oxynitride), and a material of the second inorganic encapsulation layer 63 is SiN (silicon nitride). In some other examples, the material of the first inorganic encapsulation layer 61 may be the same as the material of the second inorganic encapsulation layer 63.

In some examples, the first inorganic encapsulation layer 61 and the second inorganic encapsulation layer 63 may both be formed by deposition.

In some examples, the organic encapsulation layer 62 may select an organic material suitable for inkjet printing. The organic encapsulation layer 62 may be formed by ink jet printing (IJP).

In some embodiments, in combination with FIGS. 18 and 19, the foldable display panel 100 may further include a color filter structure layer 70. The color filter structure layer 70 is located on a side of the encapsulation layer 60 proximate to the transparent cover plate 10.

The color filter structure layer 70 includes a black matrix layer 71 and color filter units (not shown in the figures). The black matrix (BM) layer 71 includes a plurality of second opening (not shown in the figures) that are disposed at intervals and extend through the black matrix layer 71, and the color filter unit are located in the second openings.

With the above structure, the foldable display panel 100 adopts a COE (color film on encapsulation, i.e., the color film is directly formed on the encapsulation layer) technology. The COE technology is a technology that uses the color film to replace an external polarizer, and the COE technology saves a lot of production costs and has great production benefits. In addition, the foldable display panel 100 using the COE technology may have a rather high light extraction rate and a rather good bending resistance, which may meet the performance requirements of the products.

Based on the above COE structure, the first light-shielding layer 20 and the black matrix layer 71 may be disposed in the same layer. The first light-shielding layer 20 and the black matrix layer 71 may be formed by the same patterning process.

With such a provision, there is no need to separately form the first light-shielding layer 20, which may be beneficial to simplifying the manufacturing process of the foldable display panel 100. Moreover, the first light-shielding layer 20 and the black matrix layer 71 are disposed in the same layer, which is equivalent to that the first light-shielding layer 20 is disposed outside the cover plate assembly 101, which may well improve an influence of an adhesive layer bonded to the first light-shielding layer 20 on the PV value at the position of the light-transmitting area Q. In addition, since the first light-shielding layer 20 and the black matrix layer 71 are disposed as a whole layer, flatness of a film layer in the light-transmitting area Q of the foldable display panel 100 may also be reduced. Based on this, the PV value at the position of the light-transmitting area Q may be reduced to below 0.8), and even below 0.4. Thus, an influence of the first light-shielding layer 20 on the propagation direction of the light at the position of the light-transmitting area Q may further be reduced, so as to improve the clarity of photographic imaging and improve the quality of the foldable display panel 100.

In some examples, the first light-shielding layer 20 and the black matrix layer 71 may be provided in the same layer, that is, the first light-shielding layer 20 and the black matrix layer 71 may be formed by the same patterning process.

Based on this, the thickness of the first light-shielding layer 20 is equal to a thickness of the black matrix layer 71, and the thickness of the first light-shielding layer 20 is in a range of 1 μm to 1.6 μm, inclusive.
Table 1 shows variation of an optical density of the first light-shielding layer with a thickness thereof

| Thickness of | Optical density (OD) |
|---|---|
| the first light- | of the first light- |
| shielding layer (μm) | shielding layer |
| 0.8 | 2.20 |
| 1.0 | 2.75 |
| 1.2 | 3.25 |
| 1.4 | 3.70 |
| 1.6 | 4.20 |

It can be seen from Table 1 above that in a case where the thickness of the first light-shielding layer 20 is equal to or close to 1 μm, the first light-shielding layer 20 has a relatively small thickness. However, in this case, the OD value of the first light-shielding layer 20 may reach over 2.5, which may meet the light-shielding degree requirements of the first light-shielding layer 20. In addition, the first light-shielding layer 20 has the relatively small thickness, which may be beneficial to saving resources and realizing lightness and thinness of the foldable display panel 100.

In a case where the thickness of the first light-shielding layer 20 is equal to or close to 1.6 μm, the first light-shielding layer 20 has a relatively large thickness. In this case, the OD value of the first light-shielding layer 20 may reach 4.2, so that the first light-shielding layer 20 may have a rather good light-shielding effect to prevent light leakage at the position of the light-transmitting area Q in the foldable display panel 100, and will not lead to resource wasting caused by an excessively large thickness of the first light-shielding layer 20.

In some examples, the thickness of the first light-shielding layer 20 is equal to the thickness of the black matrix layer 71, and the thickness of the first light-shielding layer 20 is in a range of 1 μm to 1.4 μm, inclusive.

In a case where the thickness of the first light-shielding layer 20 is equal to or close to 1 μm, the light-shielding degree requirements of the first light-shielding layer 20 may be met while being beneficial to saving resources and realizing lightness and thinness of the foldable display panel 100.

In a case where the thickness of the first light-shielding layer 20 is equal to or close to 1.6 μm, the first light-shielding layer 20 may have a rather good light-shielding effect to prevent light leakage at the position of the light-transmitting area Q in the foldable display panel 100, and will not lead to resource wasting caused by an excessively large thickness of the first light-shielding layer 20.

For example, the thickness of the first light-shielding layer 20 is approximately 1.0 μm, 1.1 μm, 1.2 μm, 1.3 μm or 1.4 μm. However, the embodiments of the present disclosure are not limited thereto.

The introduction is made by considering an example where the thickness of the first light-shielding layer 20 is approximately 1.2 μm. In a case where the thickness of the first light-shielding layer 20 is approximately 1.2 μm, the OD value of the first light-shielding layer 20 may reach 3.25. That is, in this case, the first light-shielding layer 20 may have a relatively high optical density, so that the first light-shielding layer 20 may have a relatively good light-shielding effect, and may effectively shield the light at the position of the light-transmitting area Q in the foldable display panel 100, thereby preventing light leakage at the position of the light-transmitting area Q in the foldable display panel 100.

It will be noted that due to certain uncontrollable errors (e.g., manufacturing process error, equipment accuracy, and measurement error), in a case where a floating range of error of the thickness of the first light-shielding layer 20 is within −10%×1.2 μm to 10%×1.2 μm, it may be considered that the thickness of the first light-shielding layer 20 is equal to 1.2 μm.

In addition, in some other examples, in a case where a floating range of error of the thickness of the first light-shielding layer 20 is within −5%×1.2 μm to 5%×1.2 μm, it may be considered that the thickness of the first light-shielding layer 20 is equal to 1.2 μm.

In summary, in a case where the first light-shielding layer 20 and the black matrix layer 71 are disposed in the same layer, the thickness of the first light-shielding layer 20 may be about 1.3 μm, or even as low as 1 μm. Compared with the ink layer in the cover plate assembly 101, the first light-shielding layer 20 in the same layer as the black matrix layer 71 has a smaller thickness, and the light-shielding effect also meets the requirements. Based on this, an influence of the first light-shielding layer 20 on the propagation direction of the light at the position of the light-transmitting area Q may further be reduced, so as to improve the clarity of photographic imaging and improve the quality of the foldable display panel 100.

In some embodiments, in combination with FIG. 18, the first light-shielding layer 20 and the black matrix layer 71 are disconnected, so that the first light-shielding layer 20 and the black matrix layer 71 have a gap J therebetween. Based on this, a rainbow pattern detect may be performed at the position of the gap J between the first light-shielding layer 20 and the black matrix layer 71.

In some other embodiments, in order to improve the influence of the first light-shielding layer 20 on the PV value at the position of the light-transmitting area Q, the first light-shielding layer 20 is disposed to be in the same layer as the black matrix layer 71. That is, there is no other light-shielding layers provided on a side of the black matrix layer 71 (the first light-shielding layer 20) away from the display substrate 102, so as to prevent the PV value at the position of the light-transmitting area Q from being affected.

Based on this, in combination with FIG. 19, the first light-shielding layer 20 and the black matrix layer 71 may be connected. It can be understood that in a case where the black matrix layer 71 is formed, the black matrix layer 71 may be extended to an edge of the light-transmitting area Q, so that the black matrix layer 71 in an area around the light-transmitting area Q may further be used as the light-shielding layer 20.

With such a provision, the black matrix layer 71 may be used to effectively shield light, so as to prevent the foldable display panel 100 from leaking light, thereby improving the quality of the foldable display panel 100.

It will be noted that the above two positional relationship between the black matrix layer 71 and the first light-shielding layer 20 are not limited specifically in the embodiments of the present disclosure, and may be adjusted depending on the specific manner.

In some embodiments, in combination with FIGS. 18 and 19, since the first light-shielding layer 20 and the black matrix layer 71 are disposed in the same layer, the first light-shielding layer 20 needs to include the first opening K1, and an edge of the orthogonal projection of the light-transmitting area Q on the transparent cover plate 10 substantially overlaps with an edge of the orthogonal projection of the first opening K1 on the transparent cover plate 10.

Based on this, not only may the light at the edge of the light-transmitting area Q be shielded to improve light leakage in the light-transmitting area Q, but also the first light-shielding layer 20 may be prevented from affecting the light transmittance of the light-transmitting area Q, so as to improve the quality of the foldable display panel 100.

It will be noted that the term “substantially overlap” may include absolute overlap and approximate overlap. That is, an absolute value of an interval between the edge of the orthogonal projection of the light-transmitting area Q on the transparent cover plate 10 and the edge of the orthogonal projection of the first opening K1 on the transparent cover plate 10 does not exceed an error threshold. It can also be considered that the edge of the orthogonal projection of the light-transmitting area Q on the transparent cover plate 10 and the edge of the orthogonal projection of the first opening K1 on the transparent cover plate 10 are relatively “overlapped”. A ratio of the error threshold to a length of the light-transmitting area Q may be in a range of 1% to 5%, inclusive.

In some examples, when the black matrix layer 71 is formed, the black matrix layer 71 is provided as a whole layer. When the light-transmitting area Q of the foldable display panel 100 is subsequently cut, a portion of the black matrix layer 71 in the light-transmitting area Q may be removed together to form the first opening K1. Moreover, the first light-shielding layer 20 may include the first opening K1, and the edge of the orthogonal projection of the light-transmitting area Q on the transparent cover plate 10 substantially overlaps with the edge of the orthogonal projection of the first opening K1 on the transparent cover plate 10.

In some embodiments, in combination with FIGS. 18 and 19, the foldable display panel 100 further includes an over coating (OC) 80, and the over coating 80 is located on a side of the black matrix layer 71 away from the encapsulation layer 60. The over coating 80 is used to cover the color filter structure layer 70. In this way, the over coating 80 may play a role in protecting the color filter structure layer 70, and moreover, the over coating 80 may also play a role of planarization. When the foldable display panel 100 is subsequently formed, a surface of the over coating 80 away from the color filter structure layer 70 may be attached to the cover plate assembly 101.

In some embodiments, in combination with FIGS. 18 and 19, the foldable display panel 100 further includes an isolation dam R. The isolation dam R is disposed in the same layer as the encapsulation layer 60, and the isolation dam R is disposed around at least part of the encapsulation layer 60. Based on this, the isolation dam R may limit the encapsulation layer 60 to prevent the encapsulation layer 60 from flowing. Moreover, the isolation dam R may also improve the encapsulation capability of the light-transmitting area Q of the foldable display panel 100, thereby being beneficial to isolating erosion of moisture.

Here, “the isolation dam R is disposed around at least part of the encapsulation layer 60”, which includes the following two cases.

In the first case, the isolation dam R may have a closed-loop structure, and the isolation dam R is disposed around the encapsulation layer 60.

In the second case, the isolation dam R may have a non-closed-loop structure, and the isolation dam R is disposed around part of the encapsulation layer 60.

The embodiments of the present disclosure do not specifically limit the above two cases, and in both of the above two cases, the isolation dam R may be used to achieve an effect of improving the encapsulation capability of the light-transmitting area Q of the foldable display panel 100 to be beneficial to isolating erosion of moisture. The following description will be made by considering an example of the first case in which the isolation dam R may have a closed-loop structure, and the isolation dam R is disposed around the encapsulation layer 60.

In some embodiments, in combination with FIGS. 18 and 19, the foldable display panel 100 further includes a peripheral area FQ surrounding the light-transmitting area Q. The foldable display panel 100 further includes a plurality of first isolation columns C1. The plurality of first isolation columns C1 are located between the first light-shielding layer 20 and the encapsulation layer 60, and the plurality of first isolation columns C1 are located in the peripheral area FQ and disposed at intervals along a radial direction of the light-transmitting area Q.

With such a provision, the plurality of first isolation columns C1 may be used to improve the encapsulation capability of the light-transmitting area Q of the foldable display panel 100, which is beneficial to isolating erosion of moisture.

FIGS. 18 and 19 illustrate examples where the peripheral area FQ is provided with seven first isolation columns C1 therein. However, the number of the first isolation columns C1 in the embodiments of the present disclosure is not limited thereto.

In some embodiments, in combination with FIGS. 18 and 19, the foldable display panel 100 further includes a plurality of second isolation columns C2. The plurality of second isolation columns C2 are located between the black matrix layer 71 and the encapsulation layer 60, and the plurality of second isolation columns C2 are located in the peripheral area FQ and disposed at intervals along a radial direction of the light-transmitting area Q. The second isolation columns C2 are closer to the display area AA than the first isolation columns C1.

With such a provision, the plurality of second isolation columns C2 may be used to improve the encapsulation capability of the light-transmitting area Q of the foldable display panel 100, which is beneficial to isolating erosion of moisture.

FIGS. 18 and 19 illustrate examples where the peripheral area FQ is provided with four second isolation columns C2 therein. However, the number of the second isolation columns C2 in the embodiments of the present disclosure is not limited thereto.

In some embodiments, in combination with FIGS. 18 and 19, the display substrate 102 in the foldable display panel 100 further includes a substrate 00, and a pad layer 90 located on the substrate 00. The pad layer 90 includes a first pad layer 91 and a second pad layer 92.

In some examples, the substrate 00 may be a flexible substrate. For example, a material of the substrate 00 is an organic material. For example, the material of the substrate 00 is any of polyimide (PI), polycarbonate (PC) or polyvinyl chloride (PVC).

In some examples, the first pad layer 91 includes a plurality of first pads 911. The plurality of first pads 911 may correspond one-to-one to the first isolation columns C1, and an orthogonal projection of the first pad 911 on the substrate 00 at least partially overlaps with an orthogonal projection of the first isolation column C1 on the substrate 00.

Based on this, the first pad 911 may be used to increase the height of the first isolation column C1, so that the first isolation column C1 may well improve the encapsulation capability of the light-transmitting area Q of the foldable display panel 100, which is beneficial to isolating erosion of moisture.

The orthogonal projection of the first pad 911 on the substrate 00 at least partially overlaps with the orthogonal projection of the first isolation column C1 on the substrate 00, which may include the following three cases.

In the first case, the orthogonal projection of the first pad 911 on the substrate 00 partially overlaps with the orthogonal projection of the first isolation column C1 on the substrate 00.

In the second case, the orthogonal projection of the first pad 911 on the substrate 00 covers the orthogonal projection of the first isolation column C1 on the substrate 00.

In the third case, an edge of the orthogonal projection of the first pad 911 on the substrate 00 substantially coincides with an edge of the orthogonal projection of the first isolation column C1 on the substrate 00.

In the above three manners in the embodiments of the present disclosure, the first pads 911 may be used to increase the height of the first isolation columns C1, which is beneficial to isolating erosion of moisture. Here, since FIGS. 18 and 19 mainly introduce the position between the first light-shielding layer 20 and the black matrix layer 71, FIGS. 18 and 19 do not illustrate details of a surface of each film layer. For example, FIGS. 18 and 19 do not directly illustrate the protrusion of the film layer below the first isolation columns C1 caused by the first pads 911. However, in an actual foldable display panel, the film layer below the first isolation columns C1 should be supported by the first pads 911 to form the protrusion.

In some examples, the second pad layer 92 includes a plurality of second pads 921. The plurality of second pads 921 may correspond one-to-one to the second isolation columns C2, and an orthogonal projection of the second pad 921 on the substrate 00 at least partially overlaps with an orthogonal projection of the second isolation column C2 on the substrate 00.

Based on this, the second pad 921 may be used to increase the height of the second isolation column C2, so that the second isolation column C2 may well improve the encapsulation capability of the light-transmitting area Q of the foldable display panel 100, which is beneficial to isolating erosion of moisture.

The orthogonal projection of the second pad 921 on the substrate 00 at least partially overlaps with the orthogonal projection of the second isolation column C2 on the substrate 00, which may include the following three cases.

In the first case, the orthogonal projection of the second pad 921 on the substrate 00 partially overlaps with the orthogonal projection of the second isolation column C2 on the substrate 00.

In the second case, an edge of the orthogonal projection of the second pad 921 on the substrate 00 substantially coincides with an edge of the orthogonal projection of the second isolation column C2 on the substrate 00.

In the third case, the orthogonal projection of the second pad 921 on the substrate 00 covers the orthogonal projection of the second isolation column C2 on the substrate 00.

In the above three manners in the embodiments of the present disclosure, the second pads 921 may be used to increase the height of the second isolation columns C2, which is beneficial to isolating erosion of moisture. Here, since FIGS. 18 and 19 mainly introduce the position between the first light-shielding layer 20 and the black matrix layer 71, FIGS. 18 and 19 do not illustrate details of a surface of each film layer. For example, FIGS. 18 and 19 do not directly illustrate the protrusion of the film layer below the second isolation columns C2 caused by the second pads 921. However, in an actual foldable display panel, the film layer below the second isolation columns C2 should be supported by the second pads 921 to form the protrusion.

In some examples, the first pad layer 91 and the second pad layer 92 in the pad layer 90 are disposed in the same layer. The first pad layer 91 and the second pad layer 92 in the pad layer 90 may be formed by a single patterning process, which may be beneficial to simplifying the manufacturing process of the foldable display panel 100.

In some embodiments, in combination with FIGS. 18 and 19, the pad layer 90 may further include a third pad layer 93 disposed opposite to the first pad layer 91. The first pad layer 91 is located between the first isolation column C1 and the third pad layer 93. The third pad layer 93 is used to further increase the height of the first isolation column C1, which is beneficial to isolating erosion of moisture.

In some examples, the third pad layer 93 includes a plurality of third pads 931. The plurality of third pads 931 may correspond one-to-one to the first isolation columns C1, and an orthogonal projection of the third pad 931 on the substrate 00 at least partially overlaps with an orthogonal projection of the first isolation column C1 on the substrate 00.

Based on this, the third pad 931 may be used to increase the height of the first isolation column C1, so that the first isolation column C1 may well improve the encapsulation capability of the light-transmitting area Q of the foldable display panel 100, which is beneficial to isolating erosion of moisture.

The orthogonal projection of the third pad 931 on the substrate 00 at least partially overlaps with the orthogonal projection of the first isolation column C1 on the substrate 00, which may include the following three cases.

In the first case, the orthogonal projection of the third pad 931 on the substrate 00 partially overlaps with the orthogonal projection of the first isolation column C1 on the substrate 00.

In the second case, the orthogonal projection of the third pad 931 on the substrate 00 covers the orthogonal projection of the first isolation column C1 on the substrate 00.

In the third case, an edge of the orthogonal projection of the third pad 931 on the substrate 00 substantially coincides with an edge of the orthogonal projection of the first isolation column C1 on the substrate 00.

In the above three manners in the embodiments of the present disclosure, the third pad 931 may be used to increase the height of the first isolation columns C1, which is beneficial to isolating erosion of moisture. Here, since FIGS. 18 and 19 mainly introduce the position between the first light-shielding layer 20 and the black matrix layer 71, FIGS. 18 and 19 do not illustrate details of a surface of each film layer. For example, FIGS. 18 and 19 do not directly illustrate the protrusion of the film layer below the first isolation columns C1 caused by the third pads 931. However, in an actual foldable display panel, the film layer below the first isolation columns C1 should be supported by the third pads 931 to form the protrusion.

In some embodiments, in combination with FIGS. 18 and 19, the pad layer 90 may further include a fourth pad layer 94 disposed opposite to the second pad layer 92. The second pad layer 92 is located between the second isolation column C2 and the fourth pad layer 94. The fourth pad layer 94 is used to further increase the height of the second isolation column C2, which is beneficial to isolating erosion of moisture.

In some examples, the fourth pad layer 94 includes a plurality of fourth pads 941. The plurality of fourth pads 941 may correspond one-to-one to the second isolation columns C2, and an orthogonal projection of the fourth pad 941 on the substrate 00 at least partially overlaps with an orthogonal projection of the second isolation column C2 on the substrate 00.

Based on this, the fourth pad 941 may be used to increase the height of the second isolation column C2, so that the second isolation column C2 may well improve the encapsulation capability of the light-transmitting area Q of the foldable display panel 100, which is beneficial to isolating erosion of moisture.

The orthogonal projection of the fourth pad 941 on the substrate 00 at least partially overlaps with the orthogonal projection of the second isolation column C2 on the substrate 00, which may include the following three cases.

In the first case, the orthogonal projection of the fourth pad 941 on the substrate 00 partially overlaps with the orthogonal projection of the second isolation column C2 on the substrate 00.

In the second case, an edge of the orthogonal projection of the fourth pad 941 on the substrate 00 substantially coincides with an edge of the orthogonal projection of the second isolation column C2 on the substrate 00.

In the third case, the orthogonal projection of the fourth pad 941 on the substrate 00 covers the orthogonal projection of the second isolation column C2 on the substrate 00.

In the above three manners in the embodiments of the present disclosure, the fourth pads 941 may be used to increase the height of the second isolation columns C2, which is beneficial to isolating erosion of moisture. Here, since FIGS. 18 and 19 mainly introduce the position between the first light-shielding layer 20 and the black matrix layer 71, FIGS. 18 and 19 do not illustrate details of a surface of each film layer. For example, FIGS. 18 and 19 do not directly illustrate the protrusion of the film layer below the second isolation columns C2 caused by the fourth pads 941. However, in an actual foldable display panel, the film layer below the second isolation columns C2 should be supported by the fourth pads 941 to form the protrusion.

In some examples, the third pad layer 93 and the fourth pad layer 94 in the pad layer 90 are disposed in the same layer. Based on this, the third pad layer 93 and the fourth pad layer 94 in the pad layer 90 may be formed by a single patterning process, which may be beneficial to simplifying the manufacturing process of the foldable display panel 100.

FIG. 20 is a structural diagram of film layers of another foldable display panel in accordance with some embodiments.

In some embodiments, referring to FIG. 20 and in combination with FIG. 6, the foldable display panel 100 may further include a second light-shielding layer 01. The second light-shielding layer 01 surrounds at least part of the display area AA, so as to utilize the second light-shielding layer 01 to shield light at the edge of the display area AA of the foldable display panel 100, thereby preventing light leakage around the foldable display panel 100.

In some examples, the second light-shielding layer 01 may have a non-closed-loop structure, and the second light-shielding layer 01 is disposed around part of the display area AA.

In some other examples, the second light-shielding layer 01 may have a closed-loop structure, and the second light-shielding layer 01 is disposed around the display area AA.

The embodiments of the present disclosure do not specifically limit the above two cases, and both of the above two cases may be used to improve the light leakage at the edge of the display area AA. The following description will be made by considering an example of the second case in which the second light-shielding layer 01 may have a closed-loop structure, and the second light-shielding layer 01 is disposed around the display area AA.

Since the second light-shielding layer 01 surrounds at least part of the display area AA, an orthogonal projection of the second light-shielding layer 01 on the transparent cover plate 10 does not overlap with the orthogonal projection of the light-transmitting area Q on the transparent cover plate 10. Based on this, the provision of the position of the second light-shielding layer 01 in the foldable display panel 100 does not affect the PV value at the position of the light-transmitting area Q of the foldable display panel 100. Furthermore, the second light-shielding layer 01 may be located on a side of the first protective layer 30 proximate to the display substrate 102.

Here, the description that “the second light-shielding layer 01 being located on a side of the first protective layer 30 proximate to the display substrate 102” may include the following cases.

In the first case, in combination with FIGS. 6 and 20, the second light-shielding layer 01 may be disposed between the first protective layer 30 and the transparent cover plate 10.

For example, the second light-shielding layer 01 is disposed between the first protective layer 30 and the first adhesive layer F1.

For example, the second light-shielding layer 01 is disposed between the transparent cover plate 10 and the first adhesive layer F1.

In the second case, in a case where the foldable display panel 100 includes the first buffer layer 40, the second light-shielding layer 01 may be disposed between the transparent cover plate 10 and the first buffer layer 40.

For example, the second light-shielding layer 01 is disposed between the transparent cover plate 10 and the second adhesive layer F2.

For example, the second light-shielding layer 01 is disposed between the first buffer layer 40 and the second adhesive layer F2.

In the third case, in a case where the foldable display panel 100 includes the first buffer layer 40, the second light-shielding layer 01 may be disposed between the first buffer layer 40 and the display substrate 102.

For example, the second light-shielding layer 01 is disposed between the first buffer layer 40 and the third adhesive layer F3.

For example, the second light-shielding layer 01 is disposed between the display substrate 102 and the third adhesive layer F3.

In the fourth case, in a case where the foldable display panel 100 further includes the second buffer layer 50, the second light-shielding layer 01 may be disposed between the transparent cover plate 10 and the second buffer layer 50.

For example, the second light-shielding layer 01 is disposed between the transparent cover plate 10 and the second adhesive layer F2.

For example, the second light-shielding layer 01 is disposed between the second buffer layer 50 and the second adhesive layer F2.

In the fifth case, in a case where the foldable display panel 100 further includes the second buffer layer 50, the second light-shielding layer 01 may be disposed between the second buffer layer 50 and the first buffer layer 40.

For example, the second light-shielding layer 01 is disposed between the second buffer layer 50 and the fourth adhesive layer F4.

For example, the second light-shielding layer 01 is disposed between the first buffer layer 40 and the fourth adhesive layer F4.

In the sixth case, in a case where the foldable display panel 100 further includes the encapsulation layer 60 and the color filter structure layer 70, the second light-shielding layer 01 may be provided to be in contact with the encapsulation layer 60, and the second light-shielding layer 01 is located on a side of the encapsulation layer 60 away from the display substrate 102 and is in the same layer as the color filter structure layer 70.

The embodiments of the present disclosure do not specifically limit the above six cases. The above six cases may all improve the light leakage at the edge of the display area AA and will not affect the PV value at the position of the light-transmitting area Q of the foldable display panel 100.

In some embodiments, referring to FIG. 20, the second light-shielding layer 01 and the first light-shielding layer 20 are disposed in the same layer. The second light-shielding layer 01 and the first light-shielding layer 20 may be formed by a single patterning process, which may simplify the manufacturing process of the foldable display panel 100.

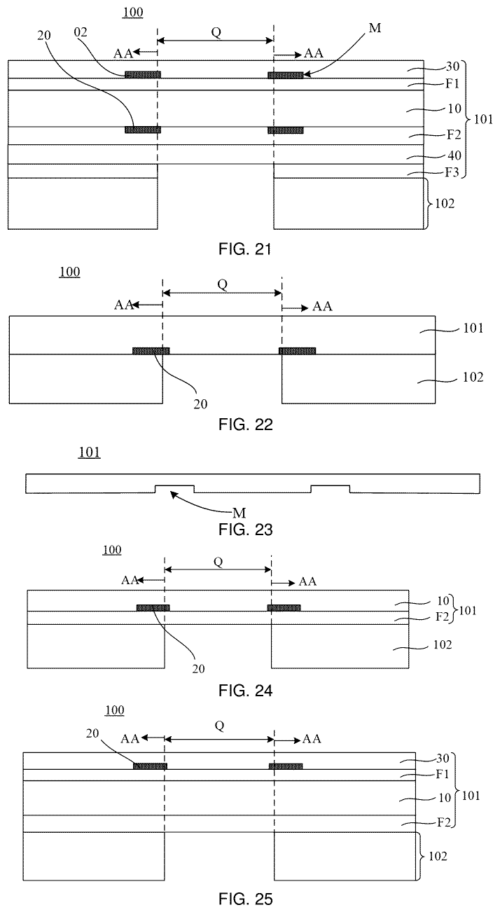

FIG. 21 is a structural diagram of film layers of another foldable display panel in accordance with some embodiments.

In some embodiments, referring to FIG. 21, the first protective layer 30 in the cover plate assembly 101 may include a groove M, and the groove M surrounds at least part of the light-transmitting area Q. The foldable display panel 100 may further include a third light-shielding layer 02, and the third light-shielding layer 02 is disposed in the groove M, so that the third light-shielding layer 02 surrounds at least part of the light-transmitting area Q.

Based on this, the third light-shielding layer 02 may be used to prevent the light leakage in the light-transmitting area Q. In addition, the third light-shielding layer 02 is disposed in the groove M to prevent unevenness of an adhesive layer adjacent to the third light-shielding layer 02 caused by the thickness of the third light-shielding layer 02 itself. That is, an uneven surface of an adhesive layer bonded to the first light-shielding layer 20 after the first light-shielding layer 20 is attached may be improved. Therefore, an influence of the adhesive layer bonded to the first light-shielding layer 20 on the PV value at the position of the light-transmitting area Q may be reduced, so that the PV value at the position of the light-transmitting area Q may be reduced to below 0.8λ. Furthermore, an influence on the propagation direction of the light at the position of the light-transmitting area Q may be reduced, thereby improving the clarity of photographic imaging and improving the quality of the foldable display panel 100.

In some examples, a depth of the groove M in the cover plate assembly 101 is substantially equal to a thickness of the third light-shielding layer 02. Based on this, in a case where the third light-shielding layer 02 is formed in the groove M, the third light-shielding layer 02 may fill the groove M, and the transparent cover plate 10 having the third light-shielding layer 02 may have an even surface.

Further, the unevenness of the film layer in the light-transmitting area Q caused by the third light-shielding layer 02 may be reduced, and an influence of the third light-shielding layer 02 on the PV value at the position of the light-transmitting area Q may be reduced, thereby improving the quality of the foldable display panel 100.

It will be noted that due to certain uncontrollable errors (e.g., manufacturing process error, equipment accuracy, and measurement error), in a case where a floating range of error of a difference between the depth of the groove M in the cover plate assembly 101 and the thickness of the third light-shielding layer 02 is within a ratio of −10% of the thickness of the third light-shielding layer 02 to the thickness of the third light-shielding layer 02 to a ratio of 10% of the thickness of the third light-shielding layer 02 to the thickness of the third light-shielding layer 02, it may be considered that the depth of the groove M in the cover plate assembly 101 is equal to thickness of the third light-shielding layer 02.

In addition, in some other examples, due to certain uncontrollable errors (e.g., manufacturing process error, equipment accuracy, and measurement error), in a case where a floating range of error of a difference between the depth of the groove M in the cover plate assembly 101 and the thickness of the third light-shielding layer 02 is within a ratio of-5% of the thickness of the third light-shielding layer 02 to the thickness of the third light-shielding layer 02 to a ratio of 5% of the thickness of the third light-shielding layer 02 to the thickness of the third light-shielding layer 02, it may be considered that the depth of the groove M in the cover plate assembly 101 is equal to thickness of the third light-shielding layer 02.

It will be noted that the first light-shielding layer 20 and the third light-shielding layer 02 may have the same material, and the difference between the first light-shielding layer 20 and the third light-shielding layer 02 is that a position of the first light-shielding layer 20 in the cover plate assembly 101 is different from a position of the third light-shielding layer 02 in the cover plate assembly 101.

In some other embodiments, the transparent cover plate 10 or the first buffer layer 40 in the cover plate assembly 101 may also be provided with a groove M therein. In some other embodiments, the second buffer layer 50 in the cover plate assembly 101 may also be provided with a groove M therein. The embodiments of the present disclosure are not limited thereto.

In some embodiments, the first light-shielding layer 20 and the third light-shielding layer 02 may be used to cooperate with each other to prevent light leakage in the light-transmitting area Q. Moreover, an influence of the first light-shielding layer 20 and the third light-shielding layer 02 on the PV value at the position of the light-transmitting area Q may also be reduced, thereby improving the quality of the foldable display panel 100.

In some of the above embodiments, the position of the first light-shielding layer 20 in the cover plate assembly 101 is adjusted, and in some other embodiments, the position of the first light-shielding layer 20 outside the cover plate assembly 101 is adjusted. That is, moving the first light-shielding layer 20 downward may reduce the influence of the first light-shielding layer 20 on the PV value at the position of the light-transmitting area Q of the foldable display panel 100. The following text provides another foldable display panel 100 in conjunction with the relevant drawings, and the influence of the first light-shielding layer 20 on the PV value at the position of the light-transmitting area Q of the foldable display panel 100 may be reduced by another means.

FIG. 22 is a structural diagram of film layers of another foldable display panel in accordance with some embodiments. FIG. 23 is a structural diagram of a cover plate assembly in FIG. 22.

In combination with FIGS. 22 and 23, the embodiments of the present disclosure provide another foldable display plane 100. The foldable display panel 100 includes a display area AA and a light-transmitting area Q. The foldable display panel 100 further includes a cover plate assembly 101 and a display substrate 102, and the cover plate assembly 101 is located on a light-exit side of the display substrate 102. The cover plate assembly 101 includes a transparent cover plate 10, and the transparent cover plate 10 is located on a light-exit side of the display substrate 102. The transparent cover plate 10 in the cover plate assembly 101 may play a role in protecting the display substrate 102.

The cover plate assembly 101 includes a groove M, and the groove M surrounds at least part of the light-transmitting area Q. The first light-shielding layer 20 is disposed in the groove M, so that the first light-shielding layer 20 surrounds at least part of the light-transmitting area Q.

Based on this, an uneven surface of an adhesive layer bonded to the first light-shielding layer 20 after the first light-shielding layer 20 is attached may be improved.

Therefore, an influence of the adhesive layer bonded to the first light-shielding layer 20 on the PV value at the position of the light-transmitting area Q may be reduced, so that the PV value at the position of the light-transmitting area Q may be reduced to below 0.8λ. Furthermore, an influence on the propagation direction of the light at the position of the light-transmitting area Q may be reduced, thereby improving the clarity of photographic imaging and improving the quality of the foldable display panel 100.

In some examples, a depth of the groove M in the cover plate assembly 101 is substantially equal to the thickness of the first light-shielding layer 20. Based on this, in a case where the first light-shielding layer 20 is formed in the groove M, the first light-shielding layer 20 may fill the groove M, and the transparent cover plate 10 having the first light-shielding layer 20 may have an even surface.

Further, the unevenness of the film layer in the light-transmitting area Q caused by the first light-shielding layer 20 may be reduced, and an influence of the first light-shielding layer 20 on the PV value at the position of the light-transmitting area Q may be reduced, thereby improving the quality of the foldable display panel 100.

It will be noted that due to certain uncontrollable errors (e.g., manufacturing process error, equipment accuracy, and measurement error), in a case where a floating range of error of a difference between the depth of the groove M in the cover plate assembly 101 and the thickness of the first light-shielding layer 20 is within a ratio of −10% of the thickness of the first light-shielding layer 20 to the thickness of the first light-shielding layer 20 to a ratio of 10% of the thickness of the first light-shielding layer 20 to the thickness of the first light-shielding layer 20, it may be considered that the depth of the groove M in the cover plate assembly 101 is equal to thickness of the first light-shielding layer 20.

In addition, in some other examples, due to certain uncontrollable errors (e.g., manufacturing process error, equipment accuracy, and measurement error), in a case where a floating range of error of a difference between the depth of the groove M in the cover plate assembly 101 and the thickness of the first light-shielding layer 20 is within a ratio of −5% of the thickness of the first light-shielding layer 20 to the thickness of the first light-shielding layer 20 to a ratio of 5% of the thickness of the first light-shielding layer 20 to the thickness of the first light-shielding layer 20, it may be considered that the depth of the groove M in the cover plate assembly 101 is equal to thickness of the first light-shielding layer 20.

FIG. 24 is a structural diagram of film layers of another foldable display panel in accordance with some embodiments, where the structure of the transparent cover plate 10 may be similar to the structure of the cover plate assembly 101 shown in FIG. 23.

In some embodiments, referring to FIG. 24 and in combination with FIG. 23, the cover plate assembly 101 may include the transparent cover plate 10. The transparent cover plate 10 is located on a light-exit side of the display substrate 102, and the transparent cover plate 10 in the cover plate assembly 101 may play a role in protecting the display substrate 102.

The transparent cover plate 10 may be provided therein with a groove M mentioned above. That is, the first light-shielding layer 20 may be formed in the groove M in the transparent cover plate 10, so that the first light-shielding layer 20 is embedded in the transparent cover plate 10. Further, the unevenness of the film layer in the light-transmitting area Q caused by the first light-shielding layer 20 may be reduced, and an influence of the first light-shielding layer 20 on the PV value at the position of the light-transmitting area Q may be reduced, thereby improving the quality of the foldable display panel 100.

The position of the groove M in the transparent cover plate 10 may include the following two cases.

In the first case, referring to FIG. 24, the groove M may be located on a side of the transparent cover plate 10 proximate to the display substrate 102.

In the second case, the groove M may be located on a side of the transparent cover plate 10 away from the display substrate 102.

In the above two cases, the first light-shielding layer 20 may be embedded in the transparent cover plate 10 to reduce the problem of uneven film layer in the light-transmitting area Q caused by the first light-shielding layer 20, so as to reduce the influence of the first light-shielding layer 20 on the PV value at the position of the light-transmitting area Q, thereby improving the quality of the foldable display panel 100.

FIG. 25 is a structural diagram of film layers of another foldable display panel in accordance with some embodiments, where the structure of the first protective layer 30 may be similar to the structure of the cover plate assembly 101 shown in FIG. 23.

In some embodiments, referring to FIG. 25 and in combination with FIG. 23, the cover plate assembly 101 may further include the first protective layer 30. The first protective layer 30 is located on a side of the transparent cover plate 10 away from the display substrate 102.

Based on this, the first protective layer 30 may be used to cover the transparent cover plate 10, so as to use the first protective layer 30 to protect the transparent cover plate 10, so that the cover plate assembly 101 has good hardness and good impact resistance.

In a case where the cover plate assembly 101 includes the transparent cover plate 10 and the first protective layer 30, the provision of the groove M may include the following two cases.

In the first case, referring to FIG. 25, the groove M may be provided in the first protective layer 30. For example, the groove M may be formed on a side of the first protective layer 30 proximate to the transparent cover plate 10, so that the groove in the first protective layer 30 is formed inside the cover plate assembly 101.

In the second case, the groove M may be provided in the transparent cover plate 10. For example, the groove M may be located on a side of the transparent cover plate 10 proximate to the display substrate 102. Alternatively, the groove M may be located on a side of the transparent cover plate 10 away from the display substrate 102.

In the above two cases, the first light-shielding layer 20 may be embedded in the cover plate assembly 101 to reduce the problem of uneven film layer in the light-transmitting area Q caused by the first light-shielding layer 20, so as to reduce the influence of the first light-shielding layer 20 on the PV value at the position of the light-transmitting area Q, thereby improving the quality of the foldable display panel 100.

In addition, since the transparent cover plate 10 is located on a side of the first protective layer 30 proximate to the display substrate 102, in a case where the groove M is disposed in the transparent cover plate 10, compared with a case where the groove M is disposed in the first protective layer 30, the groove M may be further away from the light-exit surface of the foldable display panel 100. Further, the first light-shielding layer 20 embedded in the groove M may be further away from the light-exit surface of the foldable display panel 100, so as to further reduce the influence of the first light-shielding layer 20 on the PV value at the position of the light-transmitting area Q, thereby improving the quality of the foldable display panel 100.

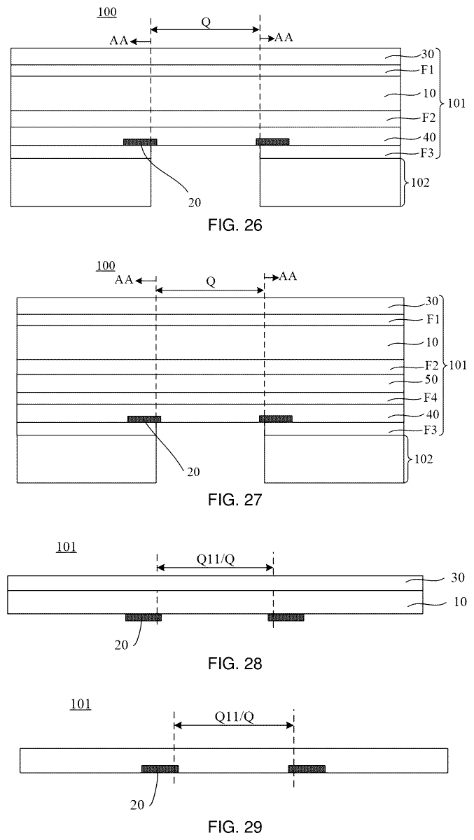

FIG. 26 is a structural diagram of film layers of another foldable display panel in accordance with some embodiments, where the structure of the first buffer layer 40 may be similar to the structure of the cover plate assembly 101 shown in FIG. 23.

In some embodiments, referring to FIG. 26 and in combination with FIG. 23, the cover plate assembly 101 may further include the first buffer layer 40. The first buffer layer 40 is located on a side of the transparent cover plate 10 proximate to the display substrate 102. The first buffer layer 40 may have relatively good buffering and recovery properties, and may play a good role in buffering and shock absorption. That is, the first buffer layer 40 may effectively absorb part of the bending stress, so as to play a role in protecting the transparent cover plate 10 to a certain extent, thereby preventing the transparent cover plate 10 from being broken when the foldable display panel 100 is impacted by external force.

In a case where the cover plate assembly 101 includes the transparent cover plate 10 and the first protective layer 30, the following three cases may be included.

In the first case, the groove M may be provided in the transparent cover plate 10. For example, the groove M may be located on a side of the transparent cover plate 10 proximate to the display substrate 102. Alternatively, the groove M may be located on a side of the transparent cover plate 10 away from the display substrate 102.

In the second case, the groove M may be provided in the first protective layer 30. For example, the groove M may be formed on a side of the first protective layer 30 proximate to the transparent cover plate 10.

In the third case, referring to FIG. 26, the groove M may be provided in the first buffer layer 40. For example, the groove M may be formed on a side of the first buffer layer 40 proximate to the display substrate 102. For example, the groove M may be formed on a side of the first buffer layer 40 away from the display substrate 102.

In the above three cases, the first light-shielding layer 20 may be embedded in the cover plate assembly 101 to reduce the problem of uneven film layer in the light-transmitting area Q caused by the first light-shielding layer 20, so as to reduce the influence of the first light-shielding layer 20 on the PV value at the position of the light-transmitting area Q, thereby improving the quality of the foldable display panel 100.

In addition, since the first buffer layer 40 is located on a side of both the first protective layer 30 and the transparent cover plate 10 proximate to the display substrate 102, in a case where the groove M is disposed in the first buffer layer 40, compared with a case where the groove M is disposed in the first protective layer 30 or in the transparent cover plate 10, the groove M may be further away from the light-exit surface of the foldable display panel 100. Further, the first light-shielding layer 20 embedded in the groove M may be further away from the light-exit surface of the foldable display panel 100, so as to further reduce the influence of the first light-shielding layer 20 on the PV value at the position of the light-transmitting area Q, thereby improving the quality of the foldable display panel 100.

FIG. 27 is a structural diagram of film layers of another foldable display panel in accordance with some embodiments, where the structure of the second buffer layer 50 may be similar to the structure of the cover plate assembly 101 shown in FIG. 23.

In addition, in a case where the cover plate assembly 101 further includes another film layer, the groove M may also be formed in the film layer. For example, the cover plate assembly 101 may further include a second buffer layer 50, and the second buffer layer 50 is disposed between the first buffer layer 40 and the transparent cover plate 10. The second buffer layer 50 may be used to further disperse the impact stress, thereby playing a role in protecting the transparent cover plate 10 and preventing the transparent cover plate 10 from being broken when the foldable display panel 100 is impacted by external force.

Based on this, in combination with FIGS. 27 and 23, the groove M may be formed on a side of the second buffer layer 50 proximate to the display substrate 102; alternatively, the groove M may be formed on a side of the second buffer layer 50 away from the display substrate 102.

Based on this, the groove M is disposed in the second buffer layer 50, which is equivalent to that the first light-shielding layer 20 embedded in the groove M is disposed at a position further away from the light-exit surface of the foldable display panel 100, so as to further reduce the influence of the first light-shielding layer 20 on the PV value at the position of the light-transmitting area Q, thereby improving the quality of the foldable display panel 100.

In some embodiments, as shown in FIG. 20 and in combination with FIG. 6, the foldable display panel 100 may further include a second light-shielding layer 01. The second light-shielding layer 01 surrounds at least part of the display area AA, so as to utilize the second light-shielding layer 01 to shield light at the edge of the display area AA of the foldable display panel 100, thereby preventing light leakage around the foldable display panel 100.

Since the second light-shielding layer 01 surrounds at least part of the display area AA, an orthogonal projection of the second light-shielding layer 01 on the transparent cover plate 10 does not overlap with the orthogonal projection of the light-transmitting area Q on the transparent cover plate 10.

Based on this, the provision of the position of the second light-shielding layer 01 in the foldable display panel 100 does not affect the PV value at the position of the light-transmitting area Q of the foldable display panel 100.

Further, the second light-shielding layer 01 may be located on a side of the first protective layer 30 proximate to the display substrate 102. Here, the description that “the second light-shielding layer 01 is located on a side of the first protective layer 30 proximate to the display substrate 102” may include the following several cases.

In the first case, the second light-shielding layer 01 is formed directly on a side of the first protective layer 30 proximate to the display substrate 102. Based on this, the second light-shielding layer 01 is used to shield the light around the display area AA of the foldable display panel 100, thereby preventing light leakage around the foldable display panel 100.

In the second case, a groove corresponding to the second light-shielding layer 01 is provided in a film layer on a side of the first protective layer 30 proximate to the display substrate 102, and the second light-shielding layer 01 is embedded in the corresponding groove. The film layer on the side of the first protective layer 30 proximate to the display substrate 102 may include the transparent cover plate 10, the first buffer layer 40 and the second buffer layer 50. Based on this, the second light-shielding layer 01 is used to shield the light around the display area AA of the foldable display panel 100, thereby preventing light leakage around the foldable display panel 100.

In some embodiments, referring to FIG. 20, the second light-shielding layer 01 and the first light-shielding layer 20 are disposed in the same layer. The second light-shielding layer 01 and the first light-shielding layer 20 may be formed by a single patterning process, which may simplify the manufacturing process of the foldable display panel 100.

FIG. 28 is a structural diagram of a cover plate assembly in accordance with some embodiments. In order to show the position of the first light-shielding layer 20 in the cover plate assembly 101, the first protective layer 30 is also illustrated.

Referring to FIG. 28, some embodiments of the present disclosure provide a cover plate assembly 101. The cover plate assembly 101 includes a light-transmitting area Q11, the cover plate assembly 101 may include a transparent cover plate 10 and a first light-shielding layer 20, the first light-shielding layer 20 is disposed on a side of the transparent cover plate 10, and the first light-shielding layer 20 is disposed around at least part of the light-transmitting area Q11.

When the cover plate assembly 101 is subsequently bonded to the display substrate 102 to form the foldable display panel 100, the light-transmitting area Q11 is the light-transmitting area Q of the foldable display panel 100, and a surface of the first light-shielding layer 20 may be bonded to the display substrate 102. That is, after the cover plate assembly 101 is bonded to the display substrate 102, the first light-shielding layer 20 is located between the transparent cover plate 10 and the display substrate 102.

Based on this, an increase in a distance between the first light-shielding layer 20 and the light-exit surface of the foldable display panel 100 may be used to reduce the influence of the adhesive layer (the second adhesive layer F2) bonded to the first light-shielding layer 20 on the PV value at the position of the light-transmitting area Q, so that the PV value at the position of the light-transmitting area Q is reduced to below 0.8λ. Furthermore, an influence on the propagation direction of the light at the position of the light-transmitting area Q may be reduced, thereby improving the clarity of photographic imaging and improving the quality of the foldable display panel 100.

In some other examples, the cover plate assembly 101 may further include a first protective layer 30, a first buffer layer 40 and a second buffer layer 50. In this case, the first light-shielding layer 20 may be disposed on a side, proximate to the display substrate 102, of any of the three film layers of the transparent cover plate 10, the first buffer layer 40 and the second buffer layer 50.

That is, the first light-shielding layer 20 is provided to move downward, so that the first light-shielding layer 20 is provided away from the first protective layer 30 to increase the distance between the first light-shielding layer 20 and the light-exit surface of the foldable display panel 100, so as to reduce the influence of the adhesive layer (the second adhesive layer F2) bonded to the first light-shielding layer 20 on the PV value at the position of the light-transmitting area Q, so that the PV value at the position of the light-transmitting area Q is reduced to below 0.8λ. Furthermore, an influence on the propagation direction of the light at the position of the light-transmitting area Q may be reduced, thereby improving the clarity of photographic imaging and improving the quality of the foldable display panel 100.

It will be noted that the structure of the cover plate assembly 101 is similar to that of the cover plate assembly 101 in the foldable display panel 100 introduced in each of the above embodiments. Reference may be made to the description of the structure of the cover plate assembly 101 in the above embodiments, and details are not repeated here.

FIG. 29 is a structural diagram of another cover plate assembly in accordance with some embodiments.

In some other examples, in combination with FIGS. 22, 23 and 29, the cover plate assembly 101 may be provided with a groove M therein, and the groove M surrounds at least part of the light-transmitting area Q11. The first light-shielding layer 20 is disposed in the groove M, so that the first light-shielding layer 20 surrounds at least part of the light-transmitting area Q11.

Based on this, an uneven surface of an adhesive layer bonded to the first light-shielding layer 20 after the first light-shielding layer 20 is attached may be improved. Therefore, an influence of the adhesive layer bonded to the first light-shielding layer 20 on the PV value at the position of the light-transmitting area Q may be reduced, so that the PV value at the position of the light-transmitting area Q may be reduced to below 0.8λ. Furthermore, an influence on the propagation direction of the light at the position of the light-transmitting area Q may be reduced, thereby improving the clarity of photographic imaging and improving the quality of the foldable display panel 100.

For the cover plate assembly 101 provided with the groove therein, in a case where the cover plate assembly 101 may further include the first protective layer 30, the first buffer layer 40 and the second buffer layer 50, the groove M may be provided in any of the four film layers of the transparent cover plate 10, the first protective layer 30, the first buffer layer 40 and the second buffer layer 50.

Based on this, in a case where the first light-shielding layer 20 is formed in the groove M, the first light-shielding layer 20 may fill the groove M, and the cover plate assembly 101 having the first light-shielding layer 20 may have an even surface. Further, the unevenness of the film layer in the light-transmitting area Q caused by the first light-shielding layer 20 may be reduced, and an influence of the first light-shielding layer 20 on the PV value at the position of the light-transmitting area Q may be reduced.

The introduction is made by considering an example where the groove M is disposed in the transparent cover plate 10. After the first light-shielding layer 20 fills the groove M, that is, after the first light-shielding layer 20 is embedded in the groove M, the transparent cover plate 10 having the first light-shielding layer 20 may have an even surface. Further, the unevenness of the film layer in the light-transmitting area Q caused by the first light-shielding layer 20 may be reduced, and an influence of the first light-shielding layer 20 on the PV value at the position of the light-transmitting area Q may be reduced.

It will be noted that the structure of the cover plate assembly 101 is similar to that of the cover plate assembly 101 in the foldable display panel 100 introduced in each of the above embodiments. Reference may be made to the description of the structure of the cover plate assembly 101 in the above embodiments, and details are not repeated here.

In addition, in some embodiments, the cover plate assembly 101 may also be provided with a second light-shielding layer 01 therein. The structure of the second light-shielding layer 01 is similar to the structure of the second light-shielding layer 01 provided in the cover plate assembly 101 in the foldable display panel 100 introduced in each of the above embodiments. Reference may further be made to the description of the structure of the second light-shielding layer 01 in the cover plate assembly 101 in the above embodiments, and details are not repeated here.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A foldable display panel, having a display area and a light-transmitting area; and the foldable display panel comprising:
a display substrate including an opening, the opening being located in the light-transmitting area;
a transparent cover plate located on a light-exit side of the display substrate;
a first buffer layer located between the transparent cover plate and the display substrate;
a first protective layer located on a side of the transparent cover plate away from the first buffer layer, wherein a material of the first protective layer is different from a material of the first buffer layer, and an elastic modulus of the first protective layer is greater than an elastic modulus of the first buffer layer; and
a first light-shielding layer, wherein the first light-shielding layer is located between the transparent cover plate and the display substrate, the first light-shielding layer surrounds at least part of the light-transmitting area, the first light-shielding layer includes a first opening, and an orthogonal projection of the light-transmitting area on the transparent cover plate at least partially overlaps with an orthogonal projection of the first opening on the transparent cover plate.

2. The foldable display panel according to claim 1, further comprising:
a second buffer layer located between the transparent cover plate and the first buffer layer, wherein a material of the second buffer layer is different from the material of the first buffer layer, and an elastic modulus of the second buffer layer is less than or equal to the elastic modulus of the first buffer layer; wherein
the first light-shielding layer is located between the second buffer layer and the transparent cover plate, or the first light-shielding layer is located between the second buffer layer and the first buffer layer.

3. The foldable display panel according to claim 2, wherein the elastic modulus of the second buffer layer is in a range of 5 MPa to 100 MPa, inclusive.

4. The foldable display panel according to claim 2, wherein a thickness of the second buffer layer is in a range of 50 μm to 200 μm, inclusive; and/or
a thickness of the second buffer layer is in range of 80 μm to 120 μm, inclusive.

5. (canceled)

6. The foldable display panel according to claim 1, further comprising:
an encapsulation layer located on a side of the display substrate proximate to the transparent cover plate; and
a color filter structure layer located on a side of the encapsulation layer proximate to the transparent cover plate, wherein the color filter structure layer includes a black matrix layer, wherein
the first light-shielding layer and the black matrix layer are disposed in a same layer.

7. The foldable display panel according to claim 1, further having a bending area located on a side of the display area, wherein
the first buffer layer includes a first side edge and a second side edge that are disposed opposite to each other, and the first side edge is located on a side of the second side edge proximate to the bending area; and
the first side edge includes a first line segment, a first arc transition segment, a second line segment, a second arc transition segment and a third line segment that are connected in sequence, the second line segment protrudes toward the second side edge relative to the first line segment and the third line segment define a groove structure, bottom corners of the groove structure are round corners, and the groove structure is located in the bending area.

8. The foldable display panel according to claim 1, wherein the elastic modulus of the first protective layer is in a range of 5.5 GPa to 7.5 GPa, inclusive.

9. The foldable display panel according to claim 1, wherein the first protective layer includes a protective substrate, a material of the protective substrate includes transparent polyimide, and a thickness of the transparent polyimide is in a range of 50 μm to 80 μm, inclusive.

10. The foldable display panel according to claim 9, wherein the thickness of the transparent polyimide is in a range of 70 μm to 80 μm, inclusive.

11. The foldable display panel according to claim 9, wherein at the first protective layer further includes a hard coating, and the hard coating is located on a side of the protective substrate away from the display substrate.

12. The foldable display panel according to claim 11, wherein a thickness of the hard coating is in a range of 5 μm to 20 μm, inclusive.

13. The foldable display panel according to claim 1, wherein the elastic modulus of the first buffer layer is in a range of 3.5 GPa to 4.5 GPa, inclusive.

14. The foldable display panel according to any-one-of claim 1, wherein a thickness of the first buffer layer is in a range of 20 μm to 100 μm, inclusive.

15. The foldable display panel according to claim 14, wherein the thickness of the first buffer layer is in a range of 20 μm to 50 μm, inclusive.

16. The foldable display panel according to claim 1, wherein the orthogonal projection of the light-transmitting area on the transparent cover plate covers the orthogonal projection of the first opening on the transparent cover plate.

17. The foldable display panel according to claim 1, further comprising:
a second light-shielding layer located on a side of the first protective layer proximate to the display substrate, the second light-shielding layer surrounding at least part of the display area.

18. The foldable display panel according to claim 17, wherein the second light-shielding layer and the first light-shielding layer are disposed in a same layer.

19. The foldable display panel according to claim 1, wherein the first protective layer includes a groove, and the groove surrounds at least part of the light-transmitting area; and
the foldable display panel further comprises a third light-shielding layer, and the third light-shielding layer is located in the groove.

20. A foldable display apparatus, comprising the foldable display panel according to claim 1.

21. The foldable display panel according to claim 1, wherein the first light-shielding layer is located between the first buffer layer and the transparent cover plate, or the first light-shielding layer is located between the first buffer layer and the display substrate.
